(19) United States
(12) Patent Application Publication
(10) Pub. No.: US 2024/0244476 A1
(43) Pub. Date: Jul. 18, 2024

(54) WIRELESS COMMUNICATION METHOD, AND DEVICES

(71) Applicant: GUANGDONG OPPO MOBILE TELECOMMUNICATIONS CORP., LTD., Dongguan (CN)

(72) Inventors: Zhe FU, Dongguan (CN); Yali GUO, Dongguan (CN)

(73) Assignee: GUANGDONG OPPO MOBILE TELECOMMUNICATIONS CORP., LTD., Dongguan (CN)

(21) Appl. No.: 18/430,539

(22) Filed: Feb. 1, 2024

Related U.S. Application Data
(63) Continuation of application No. PCT/CN2021/110388, filed on Aug. 3, 2021.

(51) Int. Cl. H04W 28/02

(52) U.S. Cl. CPC H04W 28/0268

(57) ABSTRACT

A wireless communication method, and devices are provided. The wireless communication method includes: a first core network device sending relevant information of a first unit to an access network device, wherein the first unit includes at least one of the following: a first-type frame, a first-type ADU and a first-type encoding chip.

### CROSS-REFERENCE TO RELATED APPLICATION

The present disclosure is a continuation of International Application No. PCT/CN2021/110388 filed on Aug. 3, 2021 and entitled “WIRELESS COMMUNICATION METHOD, AND DEVICES”, the disclosure of which is hereby incorporated by reference in its entirety.

### BACKGROUND

In a New Radio (NR) system, data streams of a service are all mapped to one Quality of Service (QoS) flow, and different QoS requirements are not distinguished in the QoS flow, that is, all QoSs are for the QoS flow. However, for a scenario where QoS requirements for different data streams differ greatly with each other, how to implement the mapping between a data stream and a QoS flow is an urgent problem to be solved.

### SUMMARY

Embodiments of the present disclosure provide a method for wireless communication and devices, which can implement the mapping between the data stream and the QoS flow, or the mapping between the service and the QoS flow, or the mapping between the application and the QoS flow, thereby satisfying different transmission requirements.

According to a first aspect, it is provided a method for wireless communication, which includes the following operation. A first core network device transmits relevant information of a first unit to an access network device, where the first unit includes at least one of: a first type of frame, a first type of application data unit (ADU) or a first type of encoding slice.

According to a second aspect, it is provided a method for wireless communication, which includes the following operation. An access network device acquires relevant information of a first unit, where the first unit includes at least one of: a first type of frame, a first type of ADU or a first type of encoding slice.

According to a seventh aspect, it is provided a core network device, which includes a processor and a memory. The memory is configured to store a computer program, and the processor is configured to call and execute the computer program stored in the memory to implement the above method of the first aspect.

According to an eighth aspect, it is provided an access network device, which includes a processor and a memory. The memory is configured to store a computer program, and the processor is configured to call and execute the computer program stored in the memory to implement the above method of the second aspect.

### BRIEF DESCRIPTION OF THE DRAWINGS

FIG. 1 is a schematic diagram of a communication system architecture according to an embodiment of the present disclosure.

FIG. 2 is a schematic diagram of data streams mapping to one QoS flow provided by the present disclosure.

FIG. 3 is a schematic diagram of data streams mapping to different QoS flows provided by the present disclosure.

FIG. 4 is a schematic flowchart of a method for wireless communication provided by an embodiment of the present disclosure.

FIG. 5 is a schematic flowchart of another method for wireless communication provided by an embodiment of the present disclosure.

FIG. 6 is a schematic flowchart of yet another method for wireless communication provided by an embodiment of the present disclosure.

FIG. 7 is a schematic flowchart of still another method for wireless communication provided by an embodiment of the present disclosure.

FIG. 8 is a schematic block diagram of a core network device provided by an embodiment of the present disclosure.

FIG. 9 is a schematic block diagram of an access network device provided by an embodiment of the present disclosure.

FIG. 10 is a schematic block diagram of a terminal device provided by an embodiment of the present disclosure.

FIG. 11 is a schematic block diagram of a communication device provided by an embodiment of the present disclosure.

FIG. 12 is a schematic block diagram of an apparatus provided by an embodiment of the present disclosure.

FIG. 13 is a schematic block diagram of a communication system provided by an embodiment of the present disclosure.

### DETAILED DESCRIPTION

The technical solution of the embodiments of the present disclosure will be described below in conjunction with the drawings in the embodiments of the present disclosure, and it is apparent that the described embodiments are part of the embodiments of the present disclosure, but not all of them. Based on the embodiments in the present disclosure, all other embodiments obtained by those skilled in the art without involving creative efforts fall within the scope of protection of the present disclosure.

The technical solution of the embodiments of the present disclosure may be applied to various communication systems. For example, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of NR system, an LTE-based access to unlicensed spectrum (LTE-U) system, an NR-based access to unlicensed spectrum (NR-U) system, a Non-Terrestrial networks (NTN) system, a universal mobile telecommunication system (UMTS), a wireless local area network (WLAN), a wireless fidelity (WiFi), a 5th-generation communication system or other communication systems.

Generally speaking, conventional communication systems support a limited number of connections and are easy to be implemented. However, with the development of communication technology, mobile communication systems will not only support the conventional communication, but also support, for example, a device to device (D2D) communication, a machine to machine (M2M) communication, a machine type communication (MTC), a vehicle to vehicle (V2V) communication, a vehicle to everything (V2X), etc. Embodiments of the present disclosure may also be applied to these communication systems.

In some embodiments, the communication system in the embodiments of the present disclosure may be applied to a carrier aggregation (CA) scenario, a dual connectivity (DC) scenario, and a standalone (SA) network distribution scenario.

In some embodiments, the communication system in the embodiments of the present disclosure may be applied to an unlicensed spectrum, where the unlicensed spectrum may also be considered a shared spectrum. Optionally, the communication system in the embodiments of the present disclosure may also be applied to a licensed spectrum, where the licensed spectrum may also be considered as a non-shared spectrum.

Embodiments of the present disclosure are described in combination with a network device and a terminal device. The terminal device may be referred to as user equipment (UE), an access terminal, a subscriber unit, a subscriber station, a mobile station, a mobile platform, a remote station, a remote terminal, a mobile device, a user terminal, a terminal, a wireless communication device, a user agent, or a user device.

The terminal device may be a STATION (ST) in the WLAN, it may be a cellular phone, a cordless phone, a session initiation protocol (SIP) telephone, a wireless local loop (WLL) station, a personal digital assistant (PDA) device, a handheld device with wireless communication function, a computing device or other processing device connected to wireless modem, an in-vehicle device, a wearable device, a next-generation communication system such as a terminal device in an NR network, or a terminal device in the future evolved public land mobile network (PLMN) network, etc.

In the embodiments of the present disclosure, the terminal device may be deployed on land, including indoor or outdoor, hand-held, wearable or in-vehicle. The terminal device may also be deployed on the water (such as ships, etc.). The terminal device may also be deployed on the air, such as airplanes, balloons and satellites, etc.

In the embodiments of the present disclosure, the terminal device may be a mobile phone, a pad, a computer with wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city or smart home, etc.

By way of example and not limitation, in the embodiments of the present disclosure, the terminal device may also be a wearable device. A wearable device can also be called wearable intelligent device, which is the general name of wearable devices developed by applying a wearable technology to an intelligently design daily wear, such as glasses, gloves, watches, clothing and shoes. The wearable device is a portable device that is worn directly on the body or integrated into the user's clothes or accessories. The wearable device is not only a kind of hardware device, but also realizes powerful functions through software support, data interaction and cloud interaction. Generalized wearable smart devices include full functions and large size, which may realize complete or partial functions without relying on smart phones, such as smart watches or smart glasses, and only focus on certain application functions, and the wearable smart devices need to be used in conjunction with other devices such as smart phones, such as various smart bracelets and smart jewelry for monitoring physical signs.

In the embodiments of the present disclosure, the network device may be a device for communicating with a mobile device, and the network device may be an access point (AP) in WLAN, a base transceiver station (BTS) in GSM or CDMA, a base station (NodeB, NB) in WCDMA, an evolutional node B (eNB or eNodeB) in LTE, a relay station or an access point, or an in-vehicle device, a wearable device, a network device or a base station (gNB) in NR network, a network device in future evolved PLMN network or a network device in NTN network, etc.

By way of example and not limitation, in the embodiments of the present disclosure, the network device may have mobility characteristics, for example, the network device may be a mobile device. In some embodiments, the network device can be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, and the like. In some embodiments, the network device may also be a base station arranged on land, water and the like.

In the embodiments of the present disclosure, the network device may provide services for a cell, the terminal device communicates with the network device through transmission resources (e.g. frequency domain resources, or spectrum resources) used by the cell, the cell may be a cell corresponding to a network device (e.g. a base station), the cell may belong to a macro base station or a base station corresponding to a small cell. The small cell may include a metro cell, a micro cell, a pico cell, a femto cell, etc. These small cells have the characteristics of small coverage and low transmission power, and are suitable for providing high-speed data transmission services.

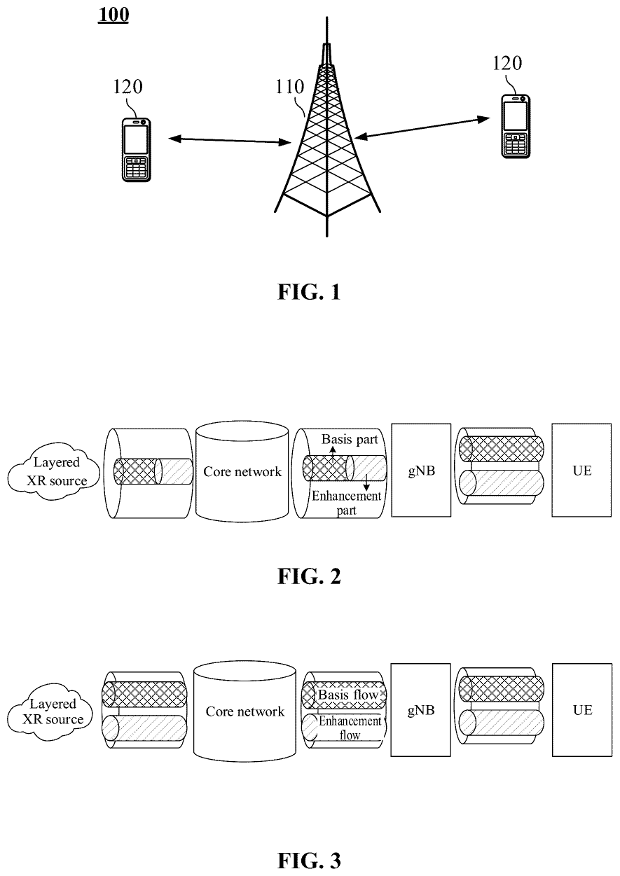

Exemplarily, a communication system 100 according to the embodiments of the present disclosure is illustrated in FIG. 1. The communication system 100 may include a network device 110, which may be a device that communicates with a terminal device 120 (or referred to as a communication terminal or a terminal). The network device 110 may provide communication coverage for a particular geographic area and may communicate with terminal devices located within the coverage area.

FIG. 1 exemplarily illustrates one network device and two terminal devices. In some embodiments, the communication system 100 may include multiple network devices and other numbers of terminal devices may be included within the coverage of each network device, which is not limited by embodiments of the present disclosure.

In some embodiments, the communication system 100 may also include other network entities such as network controllers, mobility management entities and the like, which are not limited by the embodiments of the present disclosure.

It is to be understood that a device having a communication function in a network/system in the embodiments of the present disclosure may be referred to as a communication device. Taking the communication system 100 illustrated in FIG. 1 as an example, the communication device may include a network device 110 and a terminal device 120 having a communication function, the network device 110 and the terminal device 120 may be specific devices described above and will not be elaborated here. The communication device may also include other devices in the communication system 100 such as network controllers, mobility management entities and other network entities, which are not limited in the embodiments of the present disclosure.

It is to be understood that the terms “system” and “network” of the present disclosure are often used interchangeably herein. In the present disclosure, the term “and/or” is used to describe an association relationship of associated objects, and represents that there may be three relationships. For example, A and/or B may represent the following three cases: i.e., existence of A only, existence of both A and B and existence of B only. In addition, the character “/” in the present disclosure generally represents that an “or” relationship is formed between the previous and next associated objects.

Terms used in the embodiments of the present disclosure are used only for explanation of specific embodiments of the present disclosure and are not intended to limit the present disclosure. Terms “first”, “second”, “third”, “fourth”, etc. in the description and claims of the present disclosure and the above drawings are used to distinguish different objects, and are not used to describe a particular order. Furthermore, the terms “including” and “having” and any variations thereof are intended to cover non-exclusive inclusion.

It is to be understood that the reference to “indicate” in the embodiments of the present disclosure may be a direct indication, may be an indirect indication, or may indicate an association relationship. For example, A indicates B, which can mean that A directly indicates B, for example, B may be obtained through A. It can also mean that A indirectly indicates B, for example, A indicates C, and B may be obtained by C. It can also indicate that there is an association relationship between A and B.

In the description of the embodiments of the present disclosure, the term “correspond” may mean that there is a direct correspondence or an indirect correspondence relationship between the two objects, may also mean that there is an association relationship between the two objects, may also be a relationship between indication and being indicated, configuring and being configured, etc.

In the embodiments of the present disclosure, the “predefined” or “pre-configured” may be implemented by pre-storing corresponding codes, tables, or other manners that may be used to indicate relevant information in devices (e.g., including terminal devices and network devices), the specific implementation of which is not limited by the present disclosure. For example, predefined may refer to what is defined in the protocol.

In the embodiments of the present disclosure, the “protocol” may refer to standard protocols in the communication field, such as an LTE protocol, an NR protocol, and related protocols applied in future communication systems, which are not limited herein.

In order to facilitate a better understanding of the embodiments of the present disclosure, Extended Reality (XR) or Ultra-Reliable and Low Latency Communication (URLLC) related to the present disclosure is described.

A support of the 3rd Generation Partnership Project (3GPP) system for vertical industries will be more and more extensive and in-depth. For example, the URLLC needs to support the transmission of services such as Factory automation, Transport Industry and Electrical Power Distribution in 5G systems. The XR needs to support transmission for the services of Augmented Reality (AR)/Virtual Reality (VR)/Cloud gaming.

Because when the terminal schedules resources, the QoS requirements of data transmission must be satisfied, the reliability and delay are generally required for these services. As far as terminal is concerned, it is also necessary to solve the problem of power consumption of the terminal and avoid unnecessary power consumption. Meanwhile, considering a problem of accessing a large number of terminals supporting the service, it is necessary to ensure the network capacity when allocating resources.

Typically, for URLLC/XR, the service with requirement of a minimum delay of 0.5 ms and a reliability of 99.999% is required to be supported. The service may be pseudo-cycle, that is, there is a jitter for the arrival time of the service, that is, the service will arrive at any time within a duration instead of a certain point. Meanwhile, the service cycle can be a non-integer cycle, such as 16.67 ms. In addition, arrival time of different service flows of the same service may vary greatly (for example, for AR, a cycle of the uplink pose is 4ms, but a cycle of the uplink video is 16.67 ms).

In particular, in some scenarios, there are multiple data streams in an XR and a cloud game service, and each data stream has a different QoS transmission requirement.

For example, a service from the XR or cloud gaming service may include the following form of data streams:
First manner: I-frame+P-frame;
Second manner: video+audio/data/pose (there may be I-frame and P-frame in the video);
Third manner: basic+enhancement (there may be both I-frame and P-frame in each type).

When the data streams are mapped to the QoS flows, there are two manners to adapt to the characteristics of multiple data streams in the XR and cloud game service:
Fourth manner, mapping to one QoS flow, as illustrated in FIG. 2;
Fifth manner, mapping to different QoS flows, as illustrated in FIG. 3.

In order to facilitate a better understanding of the embodiments of the present disclosure, the QoS related to the present disclosure is explained.

5G NR system supports many QoS parameters, which include 5G QoS Indicator (5QI), Assignment Restore Prioritization (ARP), bit rate and so on.

The 5QI has corresponding QoS characteristics, which include: Resource Type (such as Guaranteed Bit Rate (GBR), non-GBR, etc.), Default Priority Level, Packet Delay Budget, Default Maximum Data Burst Volume, etc.

In order to facilitate a better understanding the embodiments of the present disclosure, the related art and the existed technical problems related to the present disclosure are explained.

The data streams of an application are mapped to one QoS flow, and different QoS requirements are not distinguished in the QoS flow, that is, all QoSs are for the QoS flow (some are for the statistics of packets of the flow, such as Packet Delay Budget). However, in some scenarios, the QoS requirements of different data streams vary greatly, so the existing QoS mechanism is no longer applicable.

Based on the above problems, it is proposed a mapping scheme between data streams and QoS flows in the present disclosure.

The technical solution of the present disclosure will be described in detail by specific embodiments below.

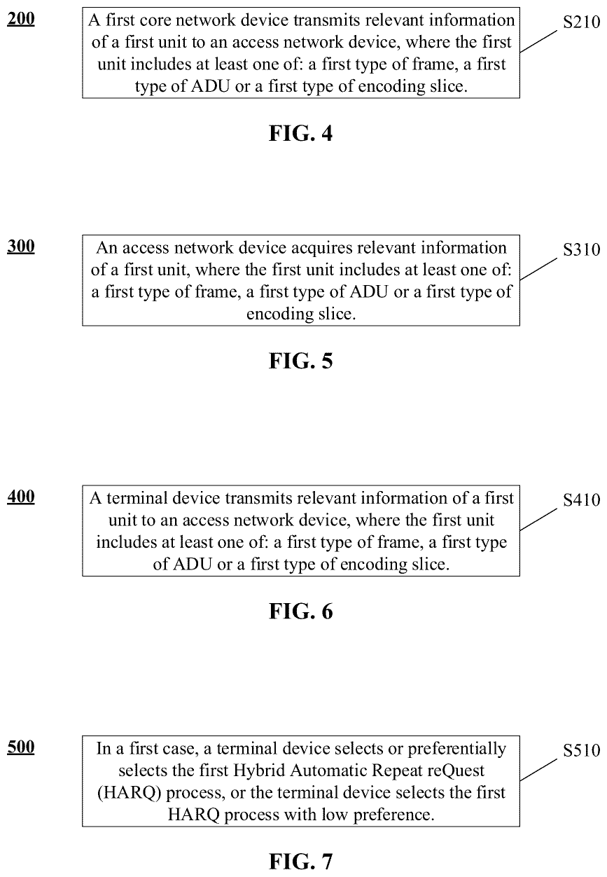

FIG. 4 is a schematic flowchart of a method for wireless communication 200 according to an embodiment of the present disclosure. As illustrated in FIG. 4, the method for wireless communication 200 may include at least part of the following operations:

At block S210, a first core network device transmits relevant information of a first unit to an access network device, where the first unit includes at least one of: a first type of frame, a first type of application data unit (ADU) or a first type of encoding slice.

In the embodiments of the present disclosure, the first core network device transmits the relevant information of the first unit to the access network device, so that the access network device can configure or schedule resources based on the relevant information of the first unit.

In the embodiments of the present disclosure, the unit may include at least one of the following: a frame, an ADU, an encoding slice. That is, in a case that the first unit is the first type of frame, the unit is a frame; in a case that the first unit is the first type of ADU, the unit is an ADU; and in a case that the first unit is the first type of encoding slice, the unit is an encoding slice.

In some embodiments, a frame of the first type of frame includes one or more special packets.

In the embodiment of the present disclosure, for the requirements of the XR service or the Configured Grant (CG) service, some of the different data streams or different units are special units or important units, or different air interfaces are required to transmit different units or data streams. That is, when different data streams of a service are mapped to one QoS flow or different QoS flows, different resource allocations or processes are performed for different data streams or different types of units to ensure the transmission requirements of different data streams or units.

In some embodiments, the first core network device may be a session management function (SMF) entity or a policy control function (PCF) entity.

In some embodiments, in a case that the first core network device is the SMF entity, the first core network device may acquire relevant information of the first unit through the PCF entity.

In some embodiments, the PCF entity may acquire the relevant information of the first unit through an Application Function (AF) entity.

In some embodiments, before the transmission of the service data, the PCF entity establishes Policy and Charging Control (PCC) rule, which may be at the service data stream level, and transmits the PCC rule to the SMF entity. Further, the SMF entity may determine an appropriate QoS flow for the received PCC rule according to the PCC rule and other information (such as terminal subscription information), so as to transmit the service data stream corresponding to the PCC rule.

Specifically, for example, one QoS flow may be used to transmit a plurality of service data streams, and one QoS flow is a collection of service data streams having the same QoS requirement.

Specifically, for another example, a plurality of service data streams of an object (such as application, an service, an application server) are mapped to different QoS flows, and different QoS flows correspond to different types of frames (for example, I-frame and P-frame), or different QoS flows correspond to different types of data streams.

In some embodiments, a configuration granularity of the relevant information of the first unit is a QoS flow.

In some embodiments, the configuration granularity of the relevant information of the first unit is not the QoS flow. For example, the configuration granularity of the relevant information of the first unit is a data stream. For another example, the configuration granularity of the relevant information of the first unit is a service. For another example, the configuration granularity of the relevant information of the first unit is an application. For another example, the configuration granularity of the relevant information of the first unit is a QoS flow group.

In some embodiments, the relevant information of the first unit is information corresponding to target information, and the target information includes at least one data stream, or the target information includes at least one service, or the target information includes at least one application, or the target information includes at least one QoS flow.

For example, the at least one service may include at least one of the following: a video service, an audio service, a video+audio service, a data service, and a pose service.

In some embodiments, the relevant information of the first unit corresponds to at least one piece of the target information, or the relevant information of the first unit is shared by all the target information, or the relevant information of the first unit is dedicated to one piece of the target information.

For example, in a case that the relevant information of the first unit corresponds to at least one piece of the target information, the relevant information of the first unit is shared by at least one piece of the target information.

In some embodiments, the relevant information of the first unit includes at least one of: data information, type information, importance information or level information.

In some embodiments, in a case that the first unit includes the first type of frame, the first type of frame includes, but is not limited to, at least one of following:
an I-frame, a P-frame, a B-frame, a conventional frame, a default frame, a user plane frame, a control plane frame or a special frame.

For example, a conventional frame may be a P-frame and/or a B-frame.

For example, the default frame may be one or more of: I-frame, P-frame, or B-frame.

For example, the special frame may be an I-frame. Other frames may also be used, which is not limited to the present disclosure.

In some embodiments, in a case that the first unit includes the first type of frame, the first type of frame may also include:
a high priority frame and a low priority frame.

In some embodiments, the high priority frame prioritizes resource allocation or scheduling.

In some embodiments, in a case that the first unit includes the first type of ADU, the first type of ADU includes, but is not limited to, at least one of following:
an I-ADU, a P-ADU, a B-ADU, a conventional ADU, a default ADU, a user plane ADU, a control plane ADU or a special ADU.

For example, a conventional ADU may be a P-ADU and/or a B-ADU.

For example, the default ADU may be one or more of: an I-ADU, a P-ADU, or a B-ADU.

For example, a special ADU may be an I-ADU. Other ADUs may also be used, which is not limited to the present disclosure.

In some embodiments, in a case that the first unit includes the first type of ADU, the first type of ADU may also include:
a high priority ADU and a low priority ADU.

In some embodiments, the high priority ADU prioritizes resource allocation or scheduling.

In some embodiments, in a case that the first unit includes the first type of encoding slice, the first type of encoding slice includes, but is not limited to, at least one of following:
an I-encoding slice, a P-encoding slice, a B-encoding slice, a conventional encoding slice, a default encoding slice, a user plane encoding slice, a control plane encoding slice or a special encoding slice.

For example, the conventional encoding slice may be a P-encoding slice and/or a B-encoding slice.

For example, the default encoding slice may be one or more of: an I-encoding slice, a P-encoding slice, or a B-encoding slice.

For example, the special encoding slice may be an I-encoding slice. Other encoding slices may also be used, which is not limited to the present disclosure.

In some embodiments, in a case that the first unit includes the first type of encoding slice, the first type of encoding slice may also include:
a high priority encoding slice and a low priority encoding slice.

In some embodiments, the high priority encoding slice prioritizes resource allocation or scheduling.

In some embodiments, the first core network device transmits first indication information to the access network device, the first indication information is used to indicate the access network device to configure or schedule resources with the first unit as a granularity.

That is, the SMF entity or the PCF entity transmits the first indication information to the access network device, so that the access network device may configure or schedule resources with the first unit as a granularity based on the first indication information.

In some embodiments, the relevant information of the first unit is time sensitive communication assistance information (TSCAI) information.

In some embodiments, the TSCAI information includes at least one of following:
a transmission direction of the first unit, an arrival time of the first unit, an deviation of the arrival time of the first unit, a cycle of the first unit, a size of the first unit or Internet protocol (IP) 5-tuple information of different types of units.

In some embodiments, the TSCAI information further includes a first correspondence; and

the first correspondence includes a correspondence between the first unit or an identification of the first unit or a type of the first unit or an importance of the first unit or a level of the first unit and at least one of:

the transmission direction of the first unit, the arrival time of the first unit, the deviation of the arrival time of the first unit, the cycle of the first unit, the size of the first unit or IP 5-tuple information.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow.

The arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some embodiments, the relevant information of the first unit is second indication information, and the second indication information is used to indicate the access network device to determine the first unit corresponding to target information. That is, the access network device may trigger the determination of the first unit corresponding to the target information based on the second indication information, so as to perform resource allocation or scheduling with the first unit as a granularity.

In some embodiments, the second indication information is specifically used to indicate a correspondence between a value of a first domain in a unit in the target information and a type of the unit; or the second indication information is specifically used to indicate a correspondence between a value of a first domain in each unit in the target information and the type of the unit.

In some embodiments, a third core network device (such as a User Plane Function (UPF) entity) may set a value of a first domain in a unit in the target information. For example, a unit with a first domain with value A is the first unit, and a unit with a first domain with value B is not the first unit. For another example, it is assumed that the unit is a frame, a frame with a first domain with value 00 is an I-frame, a frame with a first domain with value 01 is a B-frame, a frame with a first domain with value 10 is a

P-frame, and a frame with a first domain with value 11 is a default frame. After the UPF entity sets the value of the first domain in the unit in the target information, the UPF entity transmits the target information to the access network device.

In some embodiments, information indicated by the second indication information is acquired by the first core network device (such as an SMF entity) from a second core network device (such as a PCF entity), or the information indicated by the second indication information is determined by the first core network device (such as the SMF or PCF entity).

In some embodiments, the first core network device transmits first information to a third core network device (e.g. a UPF entity), the first information is used by the third core network device to identify different types of units. As such, the third core network device (such as a UPF entity) may set the value of the first domain in the unit in the target information.

In some embodiments, the first information includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the first information further includes a second correspondence.

The second correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the first core network device is an SMF entity, and the third core network device is a UPF entity; or, the first core network device is a PCF entity, and the third core network device is a UPF entity.

Specifically, for example, assuming that the unit is a frame, the UPF entity marks a special identification at a frame header, and according to the special identification, the access network device may determine whether the frame is a special frame (i.e., a first type of frame). The SMF entity informs the UPF entity of the information related to the special frame, which is used for the UPF entity to identify different types of frames and mark at the frame header. The UPF entity transmits a frame whose frame header is marked with special identification to the access network device. For example, the special identification is a specific value, which is used to distinguish different frames, and the value is located in a certain domain of the frame header, such as a frame domain. The SMF entity may indicate whether the frame of the access network device is a special frame (i.e., the representation of the special frame, such as which value of a specific position (such as a reserved position) corresponds to the special frame or corresponds to which special frame). According to the indication information (i.e. the above second indication information), the access network device determines whether the identification carried in the frame header is a special identification, and then determines the type of frame. For example, the SMF entity informs the access network device of the relationship between values of the frame domain information and the types of frames.

In some embodiments, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the relevant information of the first unit further includes a third correspondence.

The third correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the first core network device transmits QoS flow configuration information to the access network device, where the QoS flow configuration information is used to configure at least one QoS flow.

In the QoS flow configuration information, one or more data streams are mapped to one QoS flow, or one or more data streams for one application or service are mapped to one QoS flow; or
in the QoS flow configuration information, a plurality of data streams are mapped to different QoS flows, or a plurality of data streams for one application or service are mapped to different QoS flows; or
in the QoS flow configuration information, the plurality of data streams are mapped to different QoS flows, or the plurality of data streams for the one application or service are mapped to different QoS flows, and at least one QoS flow includes different types of units.

In some embodiments, the relevant information of the first unit further includes at least one of following:
a correspondence between an application and a type of the first unit, a correspondence between a service and a type of the first unit, a correspondence between a QoS flow and a type of the first unit, a correspondence between an application and a type of data stream, a correspondence between a service and a type of data stream, a correspondence between a QoS flow and a type of data stream or a correspondence between a data stream and a type of the first unit.

In some embodiments, the first core network device receives the relevant information of the first unit sent by a second core network device.

In some embodiments, the first core network device is an SMF entity and the second core network device is a PCF entity.

In some embodiments, the first core network device transmits QoS flow configuration information to the access network device, where the QoS flow configuration information is used to configure at least one QoS flow.

In the QoS flow configuration information, a plurality of data streams included in one application or service are mapped to different QoS flows, types of units in each QoS flow are different, or QoS requirements of data streams in each QoS are different, or types of data streams in each QoS flow are different, or types of services in each QoS flow are different.

In some embodiments, the access network device may configure a transmission resource for at least one QoS flow according to the relevant information of the first unit after the relevant information of the first unit is acquired.

In some embodiments, the access network device configures different transmission resources for different types of units in QoS flow of the at least one QoS flow.

In some embodiments, the access network device configures a same transmission resource for different types of units in QoS flow of the at least one QoS flow. The first unit requires reliable transmission, or the first unit uses a longer discard timer, or the first unit has priority for transmission.

In some embodiments, in a case that the relevant information of the first unit includes a correspondence between a QoS flow and a type of the first unit, or a correspondence between a QoS flow and a type of the data stream, or a correspondence between a QoS flow and a service, or a correspondence between a QoS flow and an application, the access network device configures different transmission resources for different QoS flows in the at least one QoS flow; and/or the access network device configures different transmission manners used for different QoS flows in the at least one QoS flow; and/or the access network device configures different discard timers for different QoS flows in the at least one QoS flow; and/or the access network device configures different priority transmission mechanisms for different QoS flows in the at least one QoS flow.

In some embodiments, in a case that the relevant information of the first unit includes a correspondence between an application and a type of the first unit or a correspondence between an application and a type of the data stream, the access network device configures different transmission resources for different applications; and/or the access network device configures different transmission manners used for different applications; and/or the access network device configures different discard timers for different applications; and/or the access network device configures different priority transmission mechanisms for different applications.

In some embodiments, in a case that the relevant information of the first unit includes a correspondence between a service and a type of the first unit, or a correspondence between a service and a type of the data stream, the access network device configures different transmission resources for different services; and/or the access network device configures different transmission manners used for different services; and/or the access network device configures different discard timers for different services; and/or the access network device configures different priority transmission mechanisms for different services.

In some embodiments, in a case that the relevant information of the first unit includes a correspondence between a data stream and a type of the first unit, the access network device configures different transmission resources for different data streams; and/or the access network device configures different transmission manners used for different data streams; and/or the access network device configures different discard timers for different data streams; and/or the access network device configures different priority transmission mechanisms for different data streams.

Therefore, in the embodiments of the present disclosure, the mapping between a data stream and a QoS flow, or the mapping between a service and a QoS flow, or the mapping between an application and a QoS flow can be implemented, thereby satisfying different transmission requirements.

The embodiments of the core network device side of the present disclosure is described in detail above in conjunction with FIG. 4, and the embodiments of the access network device side of the present disclosure is described in detail below in conjunction with FIG. 5, it is to be understood that the access network device side embodiment and the core network device side embodiment correspond to each other, and similar description may refer to the embodiments of the core network device side.

FIG. 5 is a schematic flowchart of a method for wireless communication 300 according to an embodiment of the present disclosure. As illustrated in FIG. 5, the method for wireless communication 300 may include at least part of the following operations.

At block S310, an access network device acquires relevant information of a first unit, where the first unit includes at least one of: a first type of frame, a first type of ADU or a first type of encoding slice.

In the embodiments of the present disclosure, the first core network device acquires the relevant information of the first unit, so that the access network device can configure or schedule resources based on the relevant information of the first unit.

In the embodiments of the present disclosure, the unit may include at least one of the following: a frame, an ADU, an encoding slice. That is, in a case that the first unit is the first type of frame, the unit is a frame; in a case that the first unit is the first type of ADU, the unit is an ADU; in a case that the first unit is the first type of encoding slice, the unit is an encoding slice.

In some embodiments, a frame of the first type of frame includes one or more special packets.

In the embodiment of the present disclosure, for the requirements of the XR service or the CG service, some of the different data streams or different units are special units or important units, or different air interfaces are required to transmit different units or data streams. That is, when different data streams of a service are mapped to one QoS flow or different QoS flows, different resource allocations or processes are used for different data streams or different types of units to ensure the transmission requirements of different data streams or units.

In some embodiments, a configuration granularity of the relevant information of the first unit is a QoS flow.

In some embodiments, the configuration granularity of the relevant information of the first unit is not the QoS flow. For example, the configuration granularity of the relevant information of the first unit is a data stream. For another example, the configuration granularity of the relevant information of the first unit is a service. For another example, the configuration granularity of the relevant information of the first unit is an application. For another example, the configuration granularity of the relevant information of the first unit is a QoS flow group.

In some embodiments, the relevant information of the first unit is information corresponding to target information, and the target information includes at least one data stream, or the target information includes at least one service, or the target information includes at least one application, or the target information includes at least one QoS flow.

For example, the at least one service may include at least one of the following: a video service, an audio service, a video+audio service, a data service, and a pose service.

In some embodiments, the relevant information of the first unit corresponds to at least one piece of the target information, or the relevant information of the first unit is shared by all the target information, or the relevant information of the first unit is dedicated to one piece of the target information.

For example, in a case that the relevant information of the first unit corresponds to at least one piece of the target information, the relevant information of the first unit is shared by at least one piece of the target information.

In some embodiments, the relevant information of the first unit includes at least one of: data information, type information, importance information or level information.

In some embodiments, in a case that the first unit includes the first type of frame, the first type of frame includes, but is not limited to, at least one of following:

an I-frame, a P-frame, a B-frame, a conventional frame, a default frame, a user plane frame, a control plane frame or a special frame.

For example, a conventional frame may be a P-frame and/or a B-frame.

For example, the default frame may be one or more of: I-frame, P-frame, or B-frame.

For example, the special frame may be an I-frame. Other frames may also be used, which is not limited to the present disclosure.

In some embodiments, in a case that the first unit includes the first type of frame, the first type of frame may also include:
a high priority frame and a low priority frame.

In some embodiments, the high priority frame prioritizes resource allocation or scheduling.

In some embodiments, in a case that the first unit includes the first type of ADU, the first type of ADU includes, but is not limited to, at least one of following:
an I-ADU, a P-ADU, a B-ADU, a conventional ADU, a default ADU, a user plane ADU, a control plane ADU or a special ADU.

For example, a conventional ADU may be a P-ADU and/or a B-ADU.

For example, the default ADU may be one or more of: an I-ADU, a P-ADU, or a B-ADU.

For example, a special ADU may be an I-ADU. Other ADUs may also be used, which is not limited to the present disclosure.

In some embodiments, in a case that the first unit includes the first type of ADU, the first type of ADU may also include:
a high priority ADU and a low priority ADU.

In some embodiments, the high priority ADU prioritizes resource allocation or scheduling.

In some embodiments, in a case that the first unit includes the first type of encoding slice, the first type of encoding slice includes, but is not limited to, at least one of following:
an I-encoding slice, a P-encoding slice, a B-encoding slice, a conventional encoding slice, a default encoding slice, a user plane encoding slice, a control plane encoding slice or a special encoding slice.

For example, the conventional encoding slice may be a P-encoding slice and/or a B-encoding slice.

For example, the default encoding slice may be one or more of: an I-encoding slice, a P-encoding slice, or a B-encoding slice.

For example, the special encoding slice may be an I-encoding slice. Other encoding slices may also be used, which is not limited to the present disclosure.

In some embodiments, in a case that the first unit includes the first type of encoding slice, the first type of encoding slice may also include:
a high priority encoding slice and a low priority encoding slice.

In some embodiments, the high priority encoding slice prioritizes resource allocation or scheduling.

In a first example, the above S310 may specifically be that:
the access network device acquires the relevant information of the first unit through a first core network device. Therefore, the access network device may configure a transmission resource for at least one QoS flow according to the relevant information of the first unit.

In some implementations of first example, the access device receives first indication information from the first core network device, the first indication information is used to indicate the access network device to configure or schedule resources with the first unit as a granularity.

In some implementations, the first core network device may be an SMF entity or a PCF entity.

That is, the SMF entity or the PCF entity transmits the first indication information to the access network device, so that the access network device may configure or schedule resources with the first unit as a granularity based on the first indication information.

In some implementations of first example, the relevant information of the first unit is TSCAI information.

In some implementations, the TSCAI information includes at least one of following:
a transmission direction of the first unit, an arrival time of the first unit, an deviation of the arrival time of the first unit, a cycle of the first unit, a size of the first unit or IP 5-tuple information of different types of units.

In some implementations, the TSCAI information further includes a first correspondence.

The first correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow.

The arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some implementations of the first example, the relevant information of the first unit is second indication information, and the second indication information is used to indicate the access network device to determine the first unit corresponding to target information. That is, the access network device may trigger the determination of the first unit corresponding to the target information based on the second indication information, so as to perform resource allocation or scheduling with the first unit as a granularity.

In some implementations, the second indication information is specifically used to indicate a correspondence between a value of a first domain in each unit in the target information and the type of the unit.

In some implementations, a third core network device (such as a UPF entity) may set a value of a first domain in a unit in the target information. For example, a unit with a first domain with value A is the first unit, and a unit with a first domain with value B is not the first unit. For another example, it is assumed that the unit is a frame, a frame with a first domain with value 00 is an I-frame, a frame with a first domain with value 01 is a B-frame, a frame with a first domain with value 10 is a P-frame, and a frame with a first domain with value 11 is a default frame. After the UPF entity sets the value of the first domain in the unit in the target information, the UPF entity transmits the target information to the access network device.

In some implementations, a value of a first domain in each unit of the target information is added or set by a third core network device (such as UPF entity), or at least one of a type, an importance or a level of the unit of the target information is added or set by the third core network device.

Specifically, for example, assuming that the unit is a frame, the UPF entity marks a special identification at a frame header, and according to the special identification, the access network device may determine whether the frame is a special frame (i.e., a first type of frame). The SMF entity informs the UPF entity of the information related to the special frame, which is used for the UPF entity to identify different types of frames and mark at the frame header. The UPF entity transmits a frame whose frame header is marked with special identification to the access network device. For example, the special identification is a specific value, which is used to distinguish different frames, and the value is located in a certain domain of the frame header, such as a frame domain. The SMF entity may indicate whether the frame of the access network device is a special frame (i.e., the representation of the special frame, such as which value of a specific position (such as a reserved position) corresponds to the special frame or corresponds to which special frame). According to the indication information (i.e. the above second indication information), the access network device determines whether the identification carried in the frame header is a special identification, and then determines the type of frame. For example, the SMF entity informs the access network device of the relationship between values of the frame domain information and the types of frames.

In some implementations of first example, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some implementations, the relevant information of the first unit further includes a third correspondence.

The third correspondence includes a correspondence between the first unit or an identification of the first unit or a type of the first unit or an importance of the first unit or a level of the first unit and at least one of:

the transmission direction of the first unit, the arrival time of the first unit, the deviation of the arrival time of the first unit, the cycle of the first unit, the size of the first unit or IP 5-tuple information.

In some implementations, the access network device receives QoS flow configuration information from the first core network device, where the QoS flow configuration information is used to configure at least one QoS flow.

In the QoS flow configuration information, one or more data streams are mapped to one QoS flow, or one or more data streams for one application or service are mapped to one QoS flow; or
in the QoS flow configuration information, a plurality of data streams are mapped to different QoS flows, or a plurality of data streams for one application or service are mapped to different QoS flows; or
in the QoS flow configuration information, the plurality of data streams are mapped to different QoS flows, or the plurality of data streams for the one application or service are mapped to different QoS flows, and at least one QoS flow includes different types of units.

In some implementations of the first example, the relevant information of the first unit further includes at least one of following:
a correspondence between an application and a type of the first unit, a correspondence between a service and a type of the first unit, a correspondence between a QoS flow and a type of the first unit, a correspondence between an application and a type of data stream, a correspondence between a service and a type of data stream, a correspondence between a QoS flow and a type of data stream or a correspondence between a data stream and a type of the first unit.

In some implementations, the access network device receives QoS flow configuration information from the first core network device, where the QoS flow configuration information is used to configure at least one QoS flow.

In the QoS flow configuration information, a plurality of data streams included in one application or service are mapped to different QoS flows, types of units in each QoS flow are different, or QoS requirements of data streams in each QoS are different, or types of data streams in each QoS flow are different, or types of services in each QoS flow are different.

In a second example, the above S310 may specifically be as follows.

The access network device acquires the relevant information of the first unit through a terminal device. Therefore, the access network device may configure a transmission resource for at least one QoS flow according to the relevant information of the first unit.

For example, the terminal device transmits the relevant information of the first unit to the access network device through terminal assistance information (UE assistance info).

In some implementations of the second example, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some implementations, the relevant information of the first unit further includes a fourth correspondence.

The fourth correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some implementations, the relevant information of the first unit further includes resource information recommended by the terminal device.

In some implementations, the recommended resource information includes at least one of following:
a starting position of CG resources, a cycle of the CG resources or a size of the CG resources.

In a third example, the above S310 may specifically be as follows.

The access network device acquires the relevant information of the first unit through pre-configuration information.

In some implementations of the third example, the pre-configuration information includes at least one of that:
at least one bit in target information corresponds to the first unit, a unit carrying a first identification in the target information is the first unit, a unit carrying a first value in the target information is the first unit.

In some implementations, the first identification includes at least one of following:
a unit identification, a basic indication, an enhancement indication, a video indication, a pose indication, a priority indication, an importance indication, a high level indication, a self-encoding indication or an I unit indication.

Specifically, for example, assuming that the unit is a frame, it is predefined which bit or bits in the frame header, and/or which identification or which value correspond to a special frame (i.e. a first type of frame) or which special frame (i.e. a first type of frame), the access network device may then determine whether the frame is a special packet (i.e. a first type of frame). Special identification such as: with and without frame identification, or I-frame and/or P-frame, or basic and/or enhancement, or video and/or pose, etc.

In some embodiments, the access network device configures a transmission resource for at least one QoS flow according to the relevant information of the first unit.

In some embodiments, the access network device configures different transmission resources for different types of units in QoS flow of the at least one QoS flow.

Specifically, for example, the access network device configures different transmission resources (such as LCH/DRB/PDCP/grant resources/BWP/carrier/cell, etc.) for different types of units in a QoS flow. The access network device informs the terminal device of the correspondence between the QoS flow/unit and the transmission resource through Radio Resource Control (RRC) reconfiguration, such as one of LCH configuration, DRB configuration, PDCP configuration or grant configuration. For example, for uplink transmission, a Non-Access Stratum (NAS) layer or a Service Data Adaptation Protocol (SDAP) layer of the terminal device identifies a QoS Flow Identifier (QFI) and a first unit, and informs the QFI and the first unit to the Access Layer (AS) of the terminal device. For example, the AS layer of the terminal device is notified by packing the header in the uplink data packet. The AS layer of the terminal device determines the uplink resource used or multiplexed according to the QFI, the first unit and the correspondence between the QoS flows/units and different transmission resources indicated by the network.

In some embodiments, the access network device configures a same transmission resource for different types of units in QoS flow of the at least one QoS flow. The first unit requires reliable transmission, or the first unit uses a longer discard timer, or the first unit has priority for transmission.

In some embodiments, in a case that the relevant information of the first unit includes a correspondence between a QoS flow and a type of the first unit, or a correspondence between a QoS flow and a type of the data stream, or a correspondence between a QoS flow and a service, or a correspondence between a QoS flow and an application, the access network device configures different transmission resources for different QoS flows in the at least one QoS flow; and/or the access network device configures different transmission manners used for different QoS flows in the at least one QoS flow; and/or the access network device configures different discard timers for different QoS flows in the at least one QoS flow; and/or the access network device configures different priority transmission mechanisms for different QoS flows in the at least one QoS flow.

In some embodiments, in a case that the relevant information of the first unit includes a correspondence between an application and a type of the first unit or a correspondence between an application and a type of the data stream, the access network device configures different transmission resources for different applications; and/or the access network device configures different transmission manners used for different applications; and/or the access network device configures different discard timers for different applications; and/or the access network device configures different priority transmission mechanisms for different applications.

In some embodiments, in a case that the relevant information of the first unit includes a correspondence between a service and a type of the first unit, or a correspondence between a service and a type of the data stream, the access network device configures different transmission resources for different services; and/or the access network device configures different transmission manners used for different services; and/or the access network device configures different discard timers for different services; and/or the access network device configures different priority transmission mechanisms for different services.

In some embodiments, in a case that the relevant information of the first unit includes a correspondence between a data stream and a type of the first unit, the access network device configures different transmission resources for different data streams; and/or the access network device configures different transmission manners used for different data streams; and/or the access network device configures different discard timers for different data streams; and/or the access network device configures different priority transmission mechanisms for different data streams.

In some embodiments, in a case that the relevant information of the first unit includes resource information recommended by a terminal device, the access network device configures the transmission resource for the at least one QoS flow according to the recommended resource information.

In some embodiments, the transmission resource includes at least one of following:
a logical channel (LCH) resource, a data radio bearer (DRB), a packet data convergence protocol (PDCP) resource, a grant resource, a carrier, a bandwidth part (BWP) or a cell.

In some embodiments, the transmission resource includes at least one of following:
a CG resource, a semi-persistent scheduling (SPS) resource or a dynamical scheduling grant resource.

Therefore, in the embodiments of the present disclosure, the mapping between a data stream and a QoS flow, or the mapping between a service and a QoS flow, or the mapping between an application and a QoS flow can be implemented, thereby satisfying different transmission requirements.

The embodiments of the core network device side of the present disclosure has been described in detail above in conjunction with FIG. 4, and the embodiments of the access network device side of the present disclosure has been described in detail in conjunction with FIG. 5, and the embodiments of the terminal device side of the present disclosure are described in detail below in conjunction with FIG. 6, it is to be understood that the embodiments of the terminal device side correspond to the embodiments of the core network device side and the access network device side, and similar description may refer to the embodiments of the core network device side and the access network device side.

FIG. 6 is a schematic flowchart of a method for wireless communication 400 according to an embodiment of the present disclosure. As illustrated in FIG. 6, the method for wireless communication 400 may include at least part of the following operations.

At S410, a terminal device transmits relevant information of a first unit to an access network device, where the first unit includes at least one of: a first type of frame, a first type of ADU or a first type of encoding slice.

In the embodiments of the present disclosure, the terminal device transmits the relevant information of the first unit to the access network device, so that the access network device can configure or schedule resources based on the relevant information of the first unit.

In the embodiments of the present disclosure, the unit may include at least one of the following: a frame, an ADU, an encoding slice. That is, in a case that the first unit is the first type of frame, the unit is a frame; in a case that the first unit is the first type of ADU, the unit is an ADU; in a case that the first unit is the first type of encoding slice, the unit is an encoding slice.

In some embodiments, a frame of the first type of frame includes one or more special packets.

In the embodiment of the present disclosure, for the requirements of the XR service or the CG service, different data streams or some of the different units are special units or important units, or different air interfaces are required to transmit different units or data streams. That is, when different data streams of a service are mapped to one QoS flow or different QoS flows, different resource allocations or processes are used for different data streams or different types of units to ensure the transmission requirements of different data streams or units.

In some embodiments, a configuration granularity of the relevant information of the first unit is a QoS flow.

In some embodiments, the configuration granularity of the relevant information of the first unit is not the QoS flow. For example, the configuration granularity of the relevant information of the first unit is a data stream. For another example, the configuration granularity of the relevant information of the first unit is a service. For another example, the configuration granularity of the relevant information of the first unit is an application. For another example, the configuration granularity of the relevant information of the first unit is a QoS flow group.

In some embodiments, the relevant information of the first unit is information corresponding to target information, and the target information includes at least one data stream, or the target information includes at least one service, or the target information includes at least one application, or the target information includes at least one QoS flow.

For example, the at least one service may include at least one of the following: a video service, an audio service, a video+audio service, a data service, and a pose service.

In some embodiments, the relevant information of the first unit corresponds to at least one piece of the target information, or the relevant information of the first unit is shared by all the target information, or the relevant information of the first unit is dedicated to one piece of the target information.

For example, in a case that the relevant information of the first unit corresponds to at least one piece of the target information, the relevant information of the first unit is shared by at least one piece of the target information.

In some embodiments, the relevant information of the first unit includes at least one of: data information, type information, importance information or level information.

In some embodiments, in a case that the first unit includes the first type of frame, the first type of frame includes, but is not limited to, at least one of following:

an I-frame, a P-frame, a B-frame, a conventional frame, a default frame, a user plane frame, a control plane frame or a special frame.

For example, a conventional frame may be a P-frame and/or a B-frame.

For example, the default frame may be one or more of: I-frame, P-frame, or B-frame.

For example, the special frame may be an I-frame. Other frames may also be used, which is not limited to the present disclosure.

In some embodiments, in a case that the first unit includes the first type of frame, the first type of frame may also include:
a high priority frame and a low priority frame.

In some embodiments, the high priority frame prioritizes resource allocation or scheduling.

In some embodiments, in a case that the first unit includes the first type of ADU, the first type of ADU includes, but is not limited to, at least one of following:
an I-ADU, a P-ADU, a B-ADU, a conventional ADU, a default ADU, a user plane ADU, a control plane ADU or a special ADU.

For example, a conventional ADU may be a P-ADU and/or a B-ADU.

For example, the default ADU may be one or more of: an I-ADU, a P-ADU, or a B-ADU.

For example, a special ADU may be an I-ADU. Other ADUs may also be used, which is not limited to the present disclosure.

In some embodiments, in a case that the first unit includes the first type of ADU, the first type of ADU may also include:
a high priority ADU and a low priority ADU.

In some embodiments, the high priority ADU prioritizes resource allocation or scheduling.

In some embodiments, in a case that the first unit includes the first type of encoding slice, the first type of encoding slice includes, but is not limited to, at least one of following:
an I-encoding slice, a P-encoding slice, a B-encoding slice, a conventional encoding slice, a default encoding slice, a user plane encoding slice, a control plane encoding slice or a special encoding slice.

For example, the conventional encoding slice may be a P-encoding slice and/or a B-encoding slice.

For example, the default encoding slice may be one or more of: an I-encoding slice, a P-encoding slice, or a B-encoding slice.

For example, the special encoding slice may be an I-encoding slice. Other encoding slices may also be used, which is not limited to the present disclosure.

In some embodiments, in a case that the first unit includes the first type of encoding slice, the first type of encoding slice may also include:
a high priority encoding slice and a low priority encoding slice.

In some embodiments, the high priority encoding slice prioritizes resource allocation or scheduling.

In some embodiments, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the relevant information of the first unit further includes a fourth correspondence.

The fourth correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit further includes resource information recommended by the terminal device.

In some embodiments, the recommended resource information includes at least one of following:

a starting position of CG resources, a cycle of the CG resources or a size of the CG resources.

In some embodiments, the access network device configures a transmission resource for at least one QoS flow according to the recommended resource information.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow.

The arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some embodiments, the terminal device acquires a QoS flow identifier and the first unit identified by a non-access stratum (NAS) or a service data adaptation protocol (SDAP) layer of the terminal device; and the terminal device determines an uplink resource used or multiplexed according to the QoS flow identifier, the first unit and a fifth correspondence; where the fifth correspondence includes a correspondence between the QoS flow and the uplink resource, or the fifth correspondence includes a correspondence between the first unit and the uplink resource.

In some embodiments, the fifth correspondence is configured by a network device.

In some embodiments, the uplink resource includes at least one of following:
an LCH resource, a DRB, a PDCP resource, a grant resource, a carrier, a BWP or a cell.

In some embodiments, the uplink resource includes one of following:
a CG resource, an SPS resource or a dynamical scheduling grant resource.

Therefore, in the embodiments of the present disclosure, the mapping between a data stream and a QoS flow, or the mapping between a service and a QoS flow, or the mapping between an application and a QoS flow can be implemented, thereby satisfying different transmission requirements.

The solution of the present disclosure will be described in detail below with a first embodiment to a fourth embodiment.

The first embodiment is described by taking the first unit as a first type of frame as an example, and the first unit as a first type of ADU or a first type of encoding slice is also applicable. That is, in the first embodiment, there are different types of frames or special frames for an application or a service or a QoS flow. By enhancing TSCAI, different data streams or frames are processed differently.

Scenarios to which the first embodiment may be applied are as follows.

A: multiple data streams are mapped to one QoS flow, or multiple data streams for an object (such as an application or a service) are mapped to one QoS flow.

B: multiple data streams are mapped to different QoS flows, or multiple data streams for an object (such as an application, a service) are mapped to different QoS flows, and there are different types of frames, such as I-frame and P-frame, in at least one QoS flow.

Specifically, the solution of the first embodiment may be implemented by operations S11 to S15.

At S11, before the service data is transmitted, the PCF entity establishes a PCC rule and transmits the PCC rule to the SMF entity, where the PCC rule is at the service data stream level.
a) Optionally, the PCF entity informs the SMF entity of the information related to the first type of frame, such as carrying the information related to the first type of frame in the PCC rule. The information related to the first type of frame includes at least one of the following: a transmission direction (UL/DL), an arrival time of the first type of frame, an deviation of the arrival time of the first type of frame, a cycle of the first type of frame, a size of the first type of frame or Internet protocol (IP) 5-tuple information of different types of frames.
b) The information related to the first type of frame may further include a correspondence between the first type of frame and a), or a correspondence between the identification of the first type of frame and a) (e.g. for determining which I-frame is, which P-frame or B-frame is, etc.).
c) Optionally, information about the UL and DL may be acquired through the AF entity.

At S12, the SMF entity determines an appropriate QoS flow for the received PCC rule according to the PCC rule and other information (such as UE subscription information), so as to transmit the service data stream corresponding to the PCC rule. Specifically,
a), one QoS flow may be used to transmit a plurality of service data streams, and is a collection of service data streams having the same QoS requirement.

At S13, the first core network entity (such as the SMF entity) determines the TSCAI information.
a) TSCAI information includes at least one of the following: a direction (UL/DL), a cycle and an arrival time.
b) further, the TSCAI information further includes at least one of the following: a transmission direction (UL/DL), an arrival time of the first type of frame, an deviation of the arrival time of the first type of frame, a cycle of the first type of frame, a size of the first type of frame or IP 5-tuple information of different types of frames.
c) the TSCAI information may further include a correspondence between the first type of frame and b), or a correspondence between the identification of the first type of frame and b) (e.g. for determining which I-frame is, which P-frame or B-frame is, etc.).

At S14, the SMF entity transmits the QoS flow configuration and TSCAI information to the base station.

At S15, after the QoS flow configuration information and the TSCAI information are received, the base station configures the corresponding wireless side resources.
a) optionally, for the UL, the relevant information of the first type of frame or the recommended corresponding configuration information may also be indicated to the base station through the UE. Specifically,
b) the relevant information of the first type of frame: an arrival time of the first type of frame, an deviation of the arrival time of the first type of frame, a cycle of the first type of frame, a size of the first type of frame or IP 5-tuple information of different types of frames.
c) the relevant information of the first type of frame may further include a correspondence between the first type of frame and b), or a correspondence between the identification of the first type of frame and b) (e.g. for determining which I-frame is, which P-frame or B-frame is, etc.).
i. The recommended corresponding configuration information may be CG information, such as a starting point and cycle of CG, a size of CG.
ii. UE indication information can be UE assistance information (UEassistanceinfo).
d) The CG/SPS resource is configured for the first type of frame.

In the first embodiment, for the requirements of the XR/CG service, some of the different data streams or different units are special units or important units, and different air interfaces are required to transmit different frames or data streams. That is, when different data streams of a service are mapped to one QoS flow or different QoS flows, different data streams or different types of frames are distinguished by the enhancement of multiple TSCAIs, and different transmissions or resource allocations are adopted to ensure the transmission requirements of different data streams or frames.

The second embodiment is described by taking the first unit as a first type of frame as an example, and the first unit as a first type of ADU or a first type of encoding slice is also applicable. That is, in the second embodiment, there are different types of frames or special frames for an application or a service or a QoS flow. For DL, the base station determines the type of frame through packet header or Cyclic Prefix (CP) signaling, and for UL, the base station determines the type of frame by determining the arrival information of frame through the UE reporting. The frames of different data streams are identified or the relevant information of the first type of frame is acquired, such that different frames use different transmissions or are allocated with different resources.

Scenarios to which second embodiment may be applied as follows.

A: multiple data streams are mapped to one QoS flow, or multiple data streams for an object (such as an application or a service) are mapped to one QoS flow.

B: multiple data streams are mapped to different QoS flows, or multiple data streams for an object (such as an application, a service) are mapped to different QoS flows, and there are different types of frames, such as I-frame and P-frame, in at least one QoS flow.

Specifically, the solution of the second embodiment may be implemented by operations S21 to S24.

At S21, before the service data is transmitted, the PCF entity establishes a PCC rule and transmits the PCC rule to the SMF entity, where the PCC rule is at the service data stream level.
a) Optionally, the PCF entity informs the SMF entity of the information related to the first type of frame, such as carrying the information related to the first type of frame in the PCC rule. The information related to the first type of frame includes at least one of the following: a transmission direction (UL/DL), an arrival time of the first type of frame, an deviation of the arrival time of the first type of frame, a cycle of the first type of frame, a size of the first type of frame or Internet protocol (IP) 5-tuple information of different types of frames.
b) The information related to the first type of frame may further include a correspondence between the first type of frame and a), or a correspondence between the identification of the first type of frame and a) (e.g. for determining which I-frame is, which P-frame or B-frame is, etc.).
c) Optionally, information about the UL and DL may be acquired through the AF entity.

At S22, the SMF entity determines an appropriate QoS flow for the received PCC rule according to the PCC rule and other information (such as UE subscription information), so as to transmit the service data stream corresponding to the PCC rule. Specifically,
a), one QoS flow may be used to transmit a plurality of service data streams, and is a collection of service data streams having the same QoS requirement.

At S23, the SMF entity transmits the QoS flow configuration to the base station.

At S24, the base station performs the corresponding wireless side resource configuration based on the QoS configuration. Specifically, the base station performs the same or different scheduling and resource allocation processes for different types of frames in one QoS flow. Accordingly, the base station needs to obtain information of type of frame, or the base station obtains the arrival information of the first type of frame.

For example:
a) for the DL, the base station determines the type of frame through the frame header and/or the CP signaling;
i. the UPF entity marks a special identification at the frame header, and according to the identification, the base station may determine whether the frame is a first type of frame.

The SMF entity informs the UPF entity of the relevant information of the first type of frame for the UPF entity to identify different types of frames and mark at the frame header.

The UPF entity transmits the frame whose frame header marked with special identification to the base station. (The special identification is a specific value, which is used to distinguish different frames, and the value is located in a certain domain of the frame header, such as the frame domain)
ii. Optionally, the SMF entity may indicate to the base station whether the frame is a first type of frame (i.e., the representation of the first type of frame, such as which value of a specific position (such as a reserved position) corresponds to the first type of frame or which special frame).The base station determines whether the identification carried in the frame header is a special identification according to the indication information sent by the SMF entity, and then determines the type of frame. Optionally, this operation can precede operation i. Optionally, the indication of the SMF entity to the base station may be the indication that the PCF entity sends to the SMF entity. (For example, the SMF entity informs the base station of the relationship between the values of the frame domain information and the types of frames). Or,
iii. It is predefined which bit or bits in the frame header, and/or which identification or which value correspond to a first type of frame or which first type of frame, the base station may then determine whether the frame is a first type of frame.

Special identification such as: with and without frame identification, or I-frame and/or P-frame, or basic and/or enhancement, or video and/or pose, etc.
b) For the UL, the base station determines the arrival information of the first type of frame through the UE reporting (then the appropriate resource may be configured).
i. Optionally, for the UL, the relevant information of the first type of frame or the recommended corresponding configuration information may also be indicated to the base station through the UE. Specifically,
information of the first type of frame: a transmission direction (UL/DL), an arrival time of the first type of frame, an deviation of the arrival time of the first type of frame, a cycle of the first type of frame, a size of the first type of frame or IP 5-tuple information of different types of frames.

The recommended corresponding configuration information may be CG information, such as a starting point and cycle of CG, a size of CG.

UE indication information may be UE assistance info.
c) The operation that the base station performs the same or different scheduling and resource allocation processes for different types of packets in one QoS flow includes following operations.
i. Different PDCP/RB/LCH are allocated, and different types of packets use different PDCP/RB/LCH, such as different CG/SPS.
ii. The same PDCP/RB/LCH are allocated, different types of packets use the same PDCP/RB/LCH, but different types of packets are processed differently. For example, for the first type of frame, such as I-frame, reliable transmission is performed, such as triggering duplicated transmission. Or, for the first type of frame, such as I-frame, a longer discard timer is used.

In the second embodiment, for the requirements of the XR/CG service, some of the different data streams or different units are special units or important units, and different air interfaces are required to transmit different type of frames or data streams. That is, when different data streams of a service are mapped to one QoS flow or different QoS flows, different resource allocations or processes are used for different data streams or different types of frames to ensure the transmission requirements of different data streams or packets. UPF entity and the base station distinguish different types of frames.

The third embodiment is described by taking the first unit as a first type of frame as an example, and the first unit as a first type of ADU or a first type of encoding slice is also applicable. That is, in the third embodiment, there are different types of frames or special frames for an application or a service or a QoS flow. For UL, UE needs to identify different data streams or different types of frames, and uses different resources to transmit different data streams or frames.

Scenarios to which third embodiment may be applied as follows.

A: multiple data streams are mapped to one QoS flow, or multiple data streams for an object (such as an application or a service) are mapped to one QoS flow.

B: multiple data streams are mapped to different QoS flows, or multiple data streams for an object (such as an application, a service) are mapped to different QoS flows, and there are different types of frames, such as I-frame and P-frame, in at least one QoS flow.

Specifically, the solution of the third embodiment may be implemented by operations S31 to S34.

At S31, before the service data is transmitted, the PCF entity establishes a PCC rule and transmits the PCC rule to the SMF entity, where the PCC rule is at the service data stream level.
a) Optionally, the PCF entity informs the SMF entity of the information related to the first type of frame, such as carrying the information related to the first type of frame in the PCC rule. The information related to the first type of frame includes at least one of the following: a transmission direction (UL/DL), an arrival time of the first type of frame, an deviation of the arrival time of the first type of frame, a cycle of the first type of frame, a size of the first type of frame or Internet protocol (IP) 5-tuple information of different types of frames.
b) The information related to the first type of frame may further include a correspondence between the first type of frame and a), or a correspondence between the identification of the first type of frame and a) (e.g. for determining which I-frame is, which P-frame or B-frame is, etc.).
c) Optionally, information about the UL and DL may be acquired through the AF entity.

At S32, the SMF entity determines an appropriate QoS flow for the received PCC rule according to the PCC rule and other information (such as UE subscription information), so as to transmit the service data stream corresponding to the PCC rule.

Specifically,
a), one QoS flow may be used to transmit a plurality of service data streams, and is a collection of service data streams having the same QoS requirement.

At S33, the SMF entity transmits the QoS flow configuration to the base station. The SMF entity transmits the QoS rule to the UE, and transmits the packet detection rule and the corresponding QoS execution rule to the UPF entity. Optionally, the SMF entity informs the base station of the relevant information of the first type of frame.

At S34, after the QoS flow configuration information is received, the base station maps the QoS flow to the appropriate radio bearer according to the QoS parameter of the QoS flow, and performs the corresponding radio side resource configuration. After the QoS flow and radio resources of the service are prepared, the service data begins to be transmitted. Specifically,
a) for the UL, the base station determines the arrival information of the first type of frame or information to be transmitted based on the information from the SMF entity or information from the UE. Optionally, the information from the SMF entity may be TSCAI information.
b) Optionally, for UL, the base station configures different resources (such as LCH/DRB/PDCP/grant, etc.) for the first type of frame/data stream and other frames/data streams of a QoS flow. The base station informs the UE of the correspondence through a RRC reconfiguration, such as one of LCH configuration, DRB configuration, PDCP configuration, or configured grant config.
c) For UL, the UE, such as the UE NAS, identifies the QFI and the first type of frame and informs the QFI and the first type of frame to the UE AS. For example, the UE AS is informed by marking a frame header in a UL packet. The UE AS determines a UL resource used or multiplexed on the basis of the information and the relationship (b) between the QoS flow/first type of frame and the different resources indicated by the network.
d) For downlink data, the base station may determine the first type of frame/data stream through TSCAI or UPF frame header. The details may refer to the relevant description of first embodiment or second embodiment, and will not be elaborated herein.

In the third embodiment, for the requirements of the XR/CG service, some of the different data streams or different units are special units or important units, and different air interfaces are required to transmit different type of frames or data streams. That is, when different data streams of a service are mapped to one QoS flow or different QoS flows, different resource allocations or processes are used for different data streams or different types of frames to ensure the transmission requirements of different data streams or packets. UE may identify different frames/data streams and use different resources configured by the network for transmission.

The fourth embodiment is described by taking the first unit as a first type of frame as an example, and the first unit as a first type of ADU or a first type of encoding slice is also applicable. That is, in the fourth embodiment, there are different types of frames or special frames for an application or a service or a QoS flow. Different types of frames, or special frames and other frames, are mapped to different QoS flows, air interfaces, such as base stations, or the relationship between the QoS flows and frame type/data stream for appropriate scheduling, transmission, etc.

Scenarios to which fourth embodiment may be applied as follows.

A: an application includes multiple data streams, which are mapped to different QoS flows. The types of frames (e.g. I-frame, P-frame, B-frame, respectively) in each QoS flow are different, or QoS requirements of data streams in each QoS are different, or types of data streams in each QoS flow are different, or types of services in each QoS flow are different.

Specifically, the solution of the fourth embodiment may be implemented by operations S41 to S44.

At S41, before the service data is transmitted, the PCF entity establishes a PCC rule and transmits the PCC rule to the SMF entity, where the PCC rule is at the service data stream level.
a) Optionally, the PCF entity informs the SMF entity of information related to the first type of frame, such as carrying the information related to the first type of frame in the PCC rule. The information related to the first type of frame includes at least one of the following: a transmission direction (UL/DL), an arrival time of the first type of frame, an deviation of the arrival time of the first type of frame, a cycle of the first type of frame, a size of the first type of frame or Internet protocol (IP) 5-tuple information of different types of frames.
b) The information related to the first type of frame may further include a correspondence between the first type of frame and a), or a correspondence between the identification of the first type of frame and a) (e.g. for determining which I-frame is, which P-frame or B-frame is, etc.).
c) Optionally, information about the UL and DL may be acquired through the AF entity.

At S42, the SMF entity determines an appropriate QoS flow for the received PCC rule according to the PCC rule and other information (such as UE subscription information), so as to transmit the service data stream corresponding to the PCC rule. Specifically,
a), one QoS flow may be used to transmit a plurality of service data streams, and is a collection of service data streams having the same QoS requirement.
b) A plurality of service data streams of an object (such as application, an service, an application server) are mapped to different QoS flows, and different QoS flows correspond to different types of frame (for example, I-frame and P-frame), or different QoS flows correspond to different types of data streams.
c) Optionally, the type information is informed to the base station through the QoS flow configuration.

At S43, the SMF entity transmits the QoS flow configuration to the base station.

At S44, the base station performs the corresponding wireless side resource configuration based on the QoS configuration. Optionally, according to the relationship between the QoS flow and the type of frame/data stream, for two QoS flows, the base station performs different scheduling and resource allocation processes for different QoS flows, even if they are the same 5QI but different types of frames. For example:
i. different PDCP/RB/LCH are allocated, or different types of frames use different CGs.

1ii. different transmission manners, such as duplicated transmission and different discard timers, etc. are used.

In the fourth embodiment, for the requirements of XR/CG services, a processing method when frames of different data streams or types of frames are mapped to different QoS flow mappings is provided.

FIG. 7 is a schematic flowchart of a method for wireless communication 500 according to an embodiment of the present disclosure. As illustrated in FIG. 7, the method for wireless communication 500 may include at least part of the following operations.

At block S510, in a first case, a terminal device selects or preferentially selects the first Hybrid Automatic Repeat reQuest (HARQ) process, or the terminal device selects the first HARQ process with low preference.

In some embodiments, in the first case, the terminal device selects or preferentially selects a first HARQ process during a HARQ process selection process. For example, it is ensured that the low priority Media Access Control Protocol Data Unit (MAC PDU) is prioritized for transmission over a general new transmission.

In some embodiments, in the first case, the terminal device selects or preferentially selects the first HARQ process during the selection of a HARQ process used for the first CG.

In some embodiments, the operation that the terminal device selects or preferentially selects the first HARQ process may also be that the terminal device selects or preferentially selects an identification of the first HARQ process.

In some embodiments, in the first case, the terminal device determines that the first HARQ process corresponds to a new transmission. Optionally, in the first case, the terminal device determines that the first HARQ process corresponds to a new transmission during the HARQ process selection process. Optionally, in the first case, the terminal device determines that the first HARQ process corresponds to a new transmission during a HARQ process used for the first CG. That is, the new transmission is guaranteed to be transmitted first.

In some embodiments, in the first case, the terminal device determines that the first HARQ process corresponds to a retransmission. Optionally, in the first case, the terminal device determines that the first HARQ process corresponds to a retransmission during the HARQ process selection process. Optionally, in the first case, the terminal device determines that the first HARQ process corresponds to a retransmission during the selection of a HARQ process used for the first CG. That is, the retransmission is prioritized for transmission over the new transmission.

In some embodiments, in the first case, the terminal device selects the first HARQ process with low preference during a HARQ process selection process. Optionally, in the first case, the terminal device selects the first HARQ process with low preference during the selection of a HARQ process used for the first CG.

In some embodiments, the first case includes, but is not limited to, at least one of that:
a CG retransmission timer (cg-RetransmissionTimer) is configured, or a first CG is configured with a CG retransmission timer;
the terminal device operates in the unlicensed frequency band;
an automatic transmission (autonomousTx) is configured, or the first CG is configured with the automatic transmission;
there is no a HARQ process corresponding to retransmission, or there is no a HARQ process in pending state, or there is no a HARQ process whose CG timer is in a running state;
there is a HARQ processes corresponding to low priority MAC PDU;
a MAC PDU corresponding to the presence of the HARQ process has been acquired, but none or at least one Physical Uplink Shared Channel (PUSCH) transmission corresponding to the acquired MAC PDU is transmitted;
a MAC PDU corresponding to the presence of the HARQ process has been acquired, but none or at least one PUSCH transmission corresponding to the acquired MAC PDU has been completed;
a MAC PDU corresponding to the presence of the HARQ process has been acquired, but a previous CG corresponding to the MAC PDU does not been preferentially transmitted;
a MAC PDU corresponding to the presence of the HARQ process has been acquired, and a size of the MAC PDU is the same as the size of the first CG; or
a MAC PDU corresponding to the presence of the HARQ process has been acquired, and a logical channel mapping limit of the MAC PDU matches (e.g. the same) with a logical channel mapping limit of the first CG.

In some embodiments, the first HARQ process includes, but is not limited to, one of the following:
a HARQ processes corresponding to the low priority MAC PDU;
a MAC PDU corresponding to the HARQ process has been acquired, but none or at least one PUSCH transmission corresponding to the acquired MAC PDU is transmitted;
a MAC PDU corresponding to the HARQ process has been acquired, but none or at least one PUSCH transmission corresponding to acquired MAC PDU has been completed;
a MAC PDU corresponding to the HARQ process has been acquired, but the previous CG corresponding to the MAC PDU does not been preferentially transmitted;
a MAC PDU corresponding to the HARQ process has been acquired, and a size of the MAC PDU is the same as the size of the first CG; or
a MAC PDU corresponding to the HARQ process has been acquired, and a logical channel mapping limit of the MAC PDU matches (e.g. the same) with a logical channel mapping limit of the first CG.

In some embodiments, the first CG includes, but is not limited to, at least one of the following:
a CG retransmission timer (cg-RetransmissionTimer) is configured;
an automatic transmission (autonomousTx) is configured;
a HARQ process sharing is supported; or
any configured CG resource.

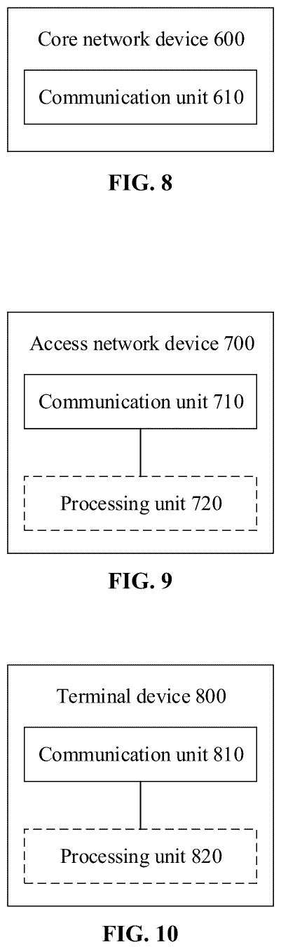

The method embodiments of the present disclosure have been described in detail above with reference to FIG. 4 to FIG. 6, and the apparatus embodiments of the present disclosure are described in detail below with reference to FIG. 8 to FIG. 10. It is to be understood that the apparatus embodiments and the method embodiments correspond to each other, and similar description may refer to the method embodiments.

FIG. 8 illustrates a schematic block diagram of a core network device 600 according to an embodiment of the present disclosure. As illustrated in FIG. 8, the core network device 600 is a first core network device, and the core network device 600 includes a communication unit 610.

The communication unit 610 is configured to transmit relevant information of the first unit to an access network device.

The first unit includes at least one of: a first type of frame, a first type of application data unit (ADU) or a first type of encoding slice.

In some embodiments, a configuration granularity of the relevant information of the first unit is a quality of service (QoS) flow, or the configuration granularity of the relevant information of the first unit is not the QoS flow.

In some embodiments, the relevant information of the first unit is information corresponding to target information, and the target information includes at least one data stream, or the target information includes at least one service, or the target information includes at least one application, or the target information includes at least one QoS flow.

In some embodiments, the relevant information of the first unit corresponds to at least one piece of the target information, or the relevant information of the first unit is shared by all the target information, or the relevant information of the first unit is dedicated to one piece of the target information.

In some embodiments, the relevant information of the first unit includes at least one of: data information, type information, importance information or level information.

In some embodiments, in a case that the first unit includes the first type of frame, the first type of frame includes at least one of following:
an I-frame, a P-frame, a B-frame, a conventional frame, a default frame, a user plane frame, a control plane frame or a special frame.

In some embodiments, in a case that the first unit includes the first type of ADU, the first type of ADU includes at least one of following:
an I-ADU, a P-ADU, a B-ADU, a conventional ADU, a default ADU, a user plane ADU, a control plane ADU or a special ADU.

In some embodiments, in a case that the first unit includes the first type of encoding slice, the first type of encoding slice includes at least one of following:

an I-encoding slice, a P-encoding slice, a B-encoding slice, a conventional encoding slice, a default encoding slice, a user plane encoding slice, a control plane encoding slice or a special encoding slice.

In some embodiments, the communication unit 610 is further configured to transmit first indication information to the access network device, the first indication information being used to indicate the access network device to configure or schedule resources with the first unit as a granularity.

In some embodiments, the relevant information of the first unit is time sensitive communication assistance information (TSCAI) information.

In some embodiments, the TSCAI information includes at least one of following:
a transmission direction of the first unit, an arrival time of the first unit, an deviation of the arrival time of the first unit, a cycle of the first unit, a size of the first unit or Internet protocol (IP) 5-tuple information of different types of units.

In some embodiments, the TSCAI information further includes a first correspondence; and

the first correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit is second indication information, the second indication information is used to indicate the access network device to determine the first unit corresponding to target information.

In some embodiments, the second indication information is specifically used to indicate a correspondence between a value of a first domain in a unit in the target information and a type of the unit; or the second indication information is specifically used to indicate a correspondence between a value of a first domain in each unit in the target information and the type of the unit.

In some embodiments, information indicated by the second indication information is acquired by the first core network device from a second core network device, or the information indicated by the second indication information is determined by the first core network device.

In some embodiments the communication unit 610 is further configured to transmit first information to a third core network device, the first information being used by the third core network device to identify different types of the first unit.

In some embodiments, the first information includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the first information further includes a second correspondence; and
the second correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the first core network device is a session management function (SMF) entity, and the third core network device is a user plane function (UPF) entity; or, the first core network device is a policy control function (PCF) entity, and the third core network device is a UPF entity.

In some embodiments, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the relevant information of the first unit further includes a third correspondence; and
the third correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow; and
the arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some embodiments, the relevant information of the first unit further includes at least one of following:
a correspondence between an application and a type of the first unit, a correspondence between a service and a type of the first unit, a correspondence between a QoS flow and a type of the first unit, a correspondence between an application and a type of data stream, a correspondence between a service and a type of data stream, a correspondence between a QoS flow and a type of data stream or a correspondence between a data stream and a type of the first unit.

In some embodiments, the communication unit 610 is further configured to receive the relevant information of the first unit sent by a second core network device.

In some embodiments, the first core network device is an SMF entity and the second core network device is a PCF entity.

In some embodiments, the first core network device is an SMF entity or a PCF entity.

In some embodiments, the first core network device transmits QoS flow configuration information to the access network device, where the QoS flow configuration information is used to configure at least one QoS flow;
in the QoS flow configuration information, one or more data streams are mapped to one QoS flow, or one or more data streams for one application or service are mapped to one QoS flow; or
in the QoS flow configuration information, a plurality of data streams are mapped to different QoS flows, or a plurality of data streams for one application or service are mapped to different QoS flows; or

1in the QoS flow configuration information, the plurality of data streams are mapped to different QoS flows, or the plurality of data streams for the one application or service are mapped to different QoS flows, and at least one QoS flow includes different types of units.

In some embodiments the communication unit 610 is further configured to transmit QoS flow configuration information to the access network device, where the QoS flow configuration information is used to configure at least one QoS flow;

in the QoS flow configuration information, a plurality of data streams included in one application or service are mapped to different QoS flows, types of units in each QoS flow are different, or QoS requirements of data streams in each QoS are different, or types of data streams in each QoS flow are different.

In some embodiments, the communication unit may be a communication interface or transceiver or an input-output interface of a communication chip or a system-on-chip.

The processing unit may be one or more processors.

It is to be understood that the core network device 600 according to the embodiment of the present disclosure may correspond to the core network device in the method embodiments of the present disclosure, and the above and other operations and/or functions of the individual units in the core network device 600 are designed to implement the respective flow of the first core network device in the method 200 illustrated in FIG. 4 respectively, which will not be elaborated here for the sake of brevity.

FIG. 9 illustrates a schematic block diagram of an access network device 700 according to an embodiment of the present disclosure. As illustrated in FIG. 9, the access network device 700 is an access network device, and the access network device 700 includes a communication unit 710.

The communication unit 710 is configured to acquire relevant information of the first unit.

The first unit includes at least one of: a first type of frame, a first type of ADU or a first type of encoding slice.

In some embodiments, a configuration granularity of the relevant information of the first unit is a QoS flow, or the configuration granularity of the relevant information of the first unit is not the QoS flow.

In some embodiments, the relevant information of the first unit is information corresponding to target information, and the target information includes at least one data stream, or the target information includes at least one service, or the target information includes at least one application, or the target information includes at least one QoS flow.

In some embodiments, the relevant information of the first unit corresponds to at least one piece of the target information, or the relevant information of the first unit is shared by all the target information, or the relevant information of the first unit is dedicated to one piece of the target information.

In some embodiments, the relevant information of the first unit includes at least one of: data information, type information, importance information or level information.

In some embodiments, in a case that the first unit includes the first type of frame, the first type of frame includes at least one of following:
an I-frame, a P-frame, a B-frame, a conventional frame, a default frame, a user plane frame, a control plane frame or a special frame.

In some embodiments, in a case that the first unit includes the first type of ADU, the first type of ADU includes at least one of following:
an I-ADU, a P-ADU, a B-ADU, a conventional ADU, a default ADU, a user plane ADU, a control plane ADU or a special ADU.

In some embodiments, in a case that the first unit includes the first type of encoding slice, the first type of encoding slice includes at least one of following:
an I-encoding slice, a P-encoding slice, a B-encoding slice, a conventional encoding slice, a default encoding slice, a user plane encoding slice, a control plane encoding slice or a special encoding slice.

In some embodiments, the communication unit 710 is specifically configured to:
acquire the relevant information of the first unit through a first core network device.

In some embodiments, the communication unit 710 is further configured to receive first indication information from the first core network device, the first indication information being used to indicate the access network device to configure or schedule resources with the first unit as a granularity.

In some embodiments, the relevant information of the first unit is time sensitive communication assistance information (TSCAI) information.

In some embodiments, the TSCAI information includes at least one of following:
a transmission direction of the first unit, an arrival time of the first unit, an deviation of the arrival time of the first unit, a cycle of the first unit, a size of the first unit or Internet protocol (IP) 5-tuple information of different types of units.

In some embodiments, the TSCAI information further includes a first correspondence; and
the first correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit is second indication information, the second indication information is used to indicate the access network device to determine the first unit corresponding to target information.

In some embodiments, the second indication information is specifically used to indicate a correspondence between a value of a first domain in each unit in the target information and the type of the unit.

In some embodiments, a value of a first domain in each unit of the target information is added or set by a third core network device, or at least one of a type, an importance or a level of each unit of the target information is added or set by the third core network device.

In some embodiments, the third core network device is a user plane function (UPF) entity.

In some embodiments, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the relevant information of the first unit further includes a third correspondence; and
the third correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit further includes at least one of following:
a correspondence between an application and a type of the first unit, a correspondence between a service and a type of the first unit, a correspondence between a QoS flow and a type of the first unit, a correspondence between an application and a type of data stream, a correspondence between a service and a type of data stream, a correspondence between a QoS flow and a type of data stream or a correspondence between a data stream and a type of the first unit.

In some embodiments, the first core network device is a session management function (SMF) entity or a policy control function (PCF) entity.

In some embodiments, the communication unit 710 is specifically configured to:
acquire the relevant information of the first unit through a terminal device.

In some embodiments, the relevant information of the first unit further includes at least one of following:
a transmission direction of the first unit, an arrival time of the first unit, an deviation of the arrival time of the first unit, a cycle of the first unit, a size of the first unit or IP 5-tuple information of different types of units.

In some embodiments, the relevant information of the first unit further includes a fourth correspondence; and
the fourth correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit further includes resource information recommended by the terminal device.

In some embodiments, recommended resource information includes at least one of following:
a starting position of configured grant (CG) resources, a cycle of the CG resources or a size of the CG resources.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow; and
the arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some embodiments, the operation that the access network device acquires the relevant information of the first unit includes that:
the access network device acquires the relevant information of the first unit through pre-configuration information.

In some embodiments, the pre-configuration information includes at least one of that:
at least one bit in target information corresponds to the first unit, a unit carrying a first identification in the target information is the first unit or a unit carrying a first value in the target information is the first unit.

In some embodiments, the first identification includes at least one of following:
a unit identification, a basic indication, an enhancement indication, a video indication, a pose indication, a priority indication, an importance indication, a high level indication, a self-encoding indication or an I unit indication.

In some embodiments, the access network device 700 further includes a processing unit 720.

The processing unit 720 is configured to configure a transmission resource for at least one QoS flow according to the relevant information of the first unit.

In some embodiments, the processing unit 720 is specifically configured to:
configure different transmission resources for different types of units in a QoS flow of the at least one QoS flow.

In some embodiments, the processing unit 720 is specifically configured to:
configure a same transmission resource for different types of units in a QoS flow in the at least one QoS flow;
the first unit requires reliable transmission, or the first unit uses a longer discard timer, or the first unit has priority for transmission.

In some embodiments, in a case that the relevant information of the first unit includes a correspondence between a QoS flow and a type of the first unit, or a correspondence between a QoS flow and a type of the data stream, or a correspondence between a QoS flow and a service, or a correspondence between a QoS flow and an application.

In some embodiments, the processing unit 720 is specifically configured to:
configure different transmission resources for different QoS flows in the at least one QoS flow; and/or
configure different transmission manners to use for different QoS flows in the at least one QoS flow; and/or
configure different discard timers for different QoS flows in the at least one QoS flow; and/or
configure different priority transmission mechanisms for different QoS flows in the at least one QoS flow.

In some embodiments, in a case that the relevant information of the first unit includes resource information recommended by a terminal device, the processing unit 720 is specifically configured to:
configure the transmission resource for the at least one QoS flow according to recommended resource information.

In some embodiments, the transmission resource includes at least one of following:
a logical channel (LCH) resource, a data radio bearer (DRB), a packet data convergence protocol (PDCP) resource, a grant resource, a carrier, a bandwidth part (BWP) or a cell.

In some embodiments, the transmission resource includes at least one of following:
a CG resource, a semi-persistent scheduling (SPS) resource or a dynamical scheduling grant resource.

In some embodiments, the communication unit may be a communication interface or transceiver or an input-output interface of a communication chip or a system-on-chip. The processing unit may be one or more processors.

It is to be understood that the access network device 700 according to the embodiment of the present disclosure may correspond to the access network device in the method embodiments of the present disclosure, and the above and other operations and/or functions of the individual units in the access network device 700 are designed to implement the respective flow of the access network device in the method 300 illustrated in FIG. 5 respectively, which will not be elaborated here for the sake of brevity.

FIG. 10 illustrates a schematic block diagram of a terminal device 800 according to an embodiment of the present disclosure. As illustrated in FIG. 10, the terminal device 800 includes a communication unit 810.

The communication unit 810 is configured to transmit relevant information of the first unit to an access network device.

The first unit includes at least one of: a first type of frame, a first type of ADU or a first type of encoding slice.

In some embodiments, a configuration granularity of the relevant information of the first unit is a QoS flow, or the configuration granularity of the relevant information of the first unit is not the QoS flow.

In some embodiments, the relevant information of the first unit is information corresponding to target information, and the target information includes at least one data stream, or the target information includes at least one service, or the target information includes at least one application, or the target information includes at least one QoS flow.

In some embodiments, the relevant information of the first unit corresponds to at least one piece of the target information, or the relevant information of the first unit is shared by all the target information, or the relevant information of the first unit is dedicated to one piece of the target information.

In some embodiments, the relevant information of the first unit includes at least one of: data information, type information, importance information or level information.

In some embodiments, in a case that the first unit includes the first type of frame, the first type of frame includes at least one of following:
an I-frame, a P-frame, a B-frame, a conventional frame, a default frame, a user plane frame, a control plane frame or a special frame.

In some embodiments, in a case that the first unit includes the first type of ADU, the first type of ADU includes at least one of following:
an I-ADU, a P-ADU, a B-ADU, a conventional ADU, a default ADU, a user plane ADU, a control plane ADU or a special ADU.

In some embodiments, in a case that the first unit includes the first type of encoding slice, the first type of encoding slice includes at least one of following:
an I-encoding slice, a P-encoding slice, a B-encoding slice, a conventional encoding slice, a default encoding slice, a user plane encoding slice, a control plane encoding slice or a special encoding slice.

In some embodiments, the relevant information of the first unit further includes at least one of following:
a transmission direction of the first unit, an arrival time of the first unit, an deviation of the arrival time of the first unit, a cycle of the first unit, a size of the first unit or Internet protocol (IP) 5-tuple information of different types of units.

In some embodiments, the relevant information of the first unit further includes a fourth correspondence; and
the fourth correspondence includes a correspondence between the first unit or an identification of the first unit or a type of the first unit or an importance of the first unit or a level of the first unit and at least one of:
the transmission direction of the first unit, the arrival time of the first unit, the deviation of the arrival time of the first unit, the cycle of the first unit, the size of the first unit or IP 5-tuple information.

In some embodiments, the relevant information of the first unit further includes resource information recommended by the terminal device.

In some embodiments, recommended resource information includes at least one of following:
a starting position of configured grant (CG) resources, a cycle of the CG resources or a size of the CG resources.

In some embodiments, the transmission direction of the first unit includes at least one of uplink or downlink.

In some embodiments, the relevant information of the first unit is information corresponding to target information, the target information includes at least one data stream, or the target information includes at least one service, or the target information includes at least one application, or the target information includes at least one QoS flow; and
the arrival time of the first unit includes at least one of following:
an arrival starting time of the first unit, an arrival ending time of the first unit, an arrival time of the first unit in each data burst, an arrival time of an earliest first unit in each data burst, an arrival time of a last first unit in each data burst, an arrival pattern of the first unit, an arrival interval of the first unit, an arrival duration of the first unit, an arrival time of an earliest first unit in the target information, an arrival time of a last first unit in the target information, an arrival time of the first unit in each data burst in the target information or an arrival time of each first unit in the target information.

In some embodiments, the terminal device 800 further includes a processing unit 820.

The communication unit 810 is further configured to acquire a QoS flow identifier identified by a non-access stratum (NAS) or a service data adaptation protocol (SDAP) layer of the terminal device and the first unit;

The processing unit 820 is configured to determine an uplink resource used or multiplexed according to the QoS flow identifier, the first unit and a fifth correspondence; and
the fifth correspondence includes a correspondence between the QoS flow and the uplink resource, or the fifth correspondence includes a correspondence between the first unit and the uplink resource.

In some embodiments, the fifth correspondence is configured by a network device.

In some embodiments, the uplink resource includes at least one of following:
a logical channel (LCH) resource, a data radio bearer (DRB), a packet data convergence protocol (PDCP) resource, a grant resource, a carrier, a bandwidth part (BWP) or a cell.

In some embodiments, the uplink resource includes one of following:
a CG resource, a semi-persistent scheduling (SPS) resource or a dynamical scheduling grant resource.

In some embodiments, the communication unit may be a communication interface or transceiver or an input-output interface of a communication chip or a system-on-chip.

The processing unit may be one or more processors.

It is to be understood that the terminal device 800 according to the embodiment of the present disclosure may correspond to the terminal device in the method embodiment of the present disclosure, and the above and other operations and/or functions of the individual units in the terminal device 800 are designed to implement the respective flow of the second network device in the method 400 illustrated in FIG. 6, respectively, which will not be repeated here for the sake of brevity.

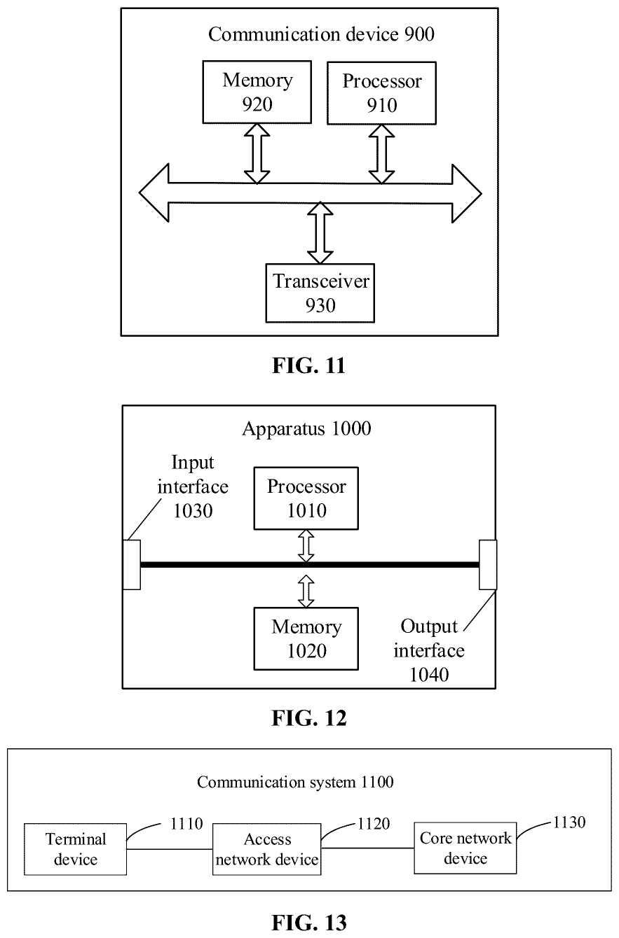

FIG. 11 is a schematic structural diagram of a communication device 900 provided by an embodiment of the present disclosure. A communication device 900 illustrated in

FIG. 11 includes a processor 910 that can call and execute a computer program from a memory to implement the method in the embodiments of the present disclosure.

In some embodiments, as illustrated in FIG. 11, the communication device 900 may also include a memory 920. The processor 910 may call and execute a computer program from memory 920 to implement the method in the embodiments of the present disclosure.

The memory 920 may be a separate device independent from the processor 910 or may be integrated in the processor 910.

In some embodiments, as illustrated in FIG. 11, the communication device 900 may also include a transceiver 930. The processor 910 may control the transceiver 930 to communicate with other devices, and in particular send information or data to other devices, or receive information or data sent by other devices.

The transceiver 930 may include a transmitter and a receiver. The transceiver 930 may further include antennas. The number of antennas may be one or more.

In some embodiments, the communication device 900 may be specifically a network device of the embodiments of the present disclosure, and the communication device 900 may implement corresponding processes implemented by the network device in various methods of the embodiments of the present disclosure, which will not be elaborated here for the sake of brevity.

In some embodiments, the communication device 900 specifically may be a terminal device of the embodiments of the present disclosure, and the communication device 900 may implement corresponding processes implemented by the terminal device in the respective methods of the embodiments of the present disclosure, which will not be elaborated here for the sake of brevity.

FIG. 12 is a schematic structural diagram of an apparatus according to an embodiment of the present disclosure. An apparatus 1000 illustrated in FIG. 12 includes a processor 1010 that may call and execute a computer program from memory to implement the method in embodiments of the present disclosure.

In some embodiments, as illustrated in FIG. 12, the apparatus 1000 may also include a memory 1020. The processor 1010 may call and execute a computer program from memory 1020 to implement the method in the embodiments of the present disclosure.

The memory 1020 may be a separate device independent from the processor 1010 or may be integrated in the processor 1010.

In some embodiments, the apparatus 1000 may also include an input interface 1030. The processor 1010 may control the input interface 1030 to communicate with other devices or chips, and in particular obtain information or data sent by other devices or chips.

In some embodiments, the apparatus 1000 may also include an output interface 1040. The processor 1010 may control the output interface 1040 to communicate with other devices or chips, and in particular output information or data to other devices or chips.

In some embodiments, the apparatus may applied to be a core network device of embodiments of the present disclosure, and the apparatus may implement corresponding processes implemented by the first core network device in the respective methods of the embodiments of the present disclosure, which will not be elaborated here for the sake of brevity.

In some embodiments, the apparatus may applied to be an access network device of embodiments of the present disclosure, and the apparatus may implement corresponding processes implemented by the access network device in the respective methods of the embodiments of the present disclosure, which will not be elaborated here for the sake of brevity.

In some embodiments, the apparatus may applied to be a terminal device of an embodiments of the present disclosure, and the apparatus may implement corresponding processes implemented by the terminal device in the respective methods of the embodiments of the present disclosure, which will not be elaborated here for the sake of brevity.

In some embodiments, the apparatus mentioned in the embodiment of the present disclosure may also be a chip. It is to be understood that the chip referred to in embodiments of the present disclosure may also be referred to as system-level chip, system chip, chip system or system-on-chip or the like.

FIG. 13 is a schematic block diagram of a communication system 1100 provided by an embodiment of the present disclosure. As illustrated in FIG. 13, the communication system 1100 includes a terminal device 1110, an access network device 1120 and a core network device 1130.

The terminal device 1110 may be configured to implement corresponding functions implemented by the terminal device in the above method, the access network device 1120 may be configured to implement corresponding functions implemented by the access network device in the above method, and the core network device 1130 may be configured to implement corresponding functions implemented by the first core network device in the above method, which will not be repeated here for the sake of brevity.

It is to be understood that the processor may be an integrated circuit chip having signal processing capability. In implementation, the operations of the above method embodiments may be accomplished by integrated logic circuitry of hardware in processor or instructions in the form of software. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, operations and logic diagrams disclosed in the embodiments of the present disclosure. The general purpose processor can be a microprocessor or any conventional processor. The operations of the method disclosed in the embodiments of the present disclosure may be directly embodied as being executed by a hardware decoding processor or being executed by the hardware and software modules in a decoding processor. The software modules may be located in a random access memory, a flash memory, a read-only memory, a programmable read-only memory or an electrically erasable programmable memory, a register and other mature storage media in the art. The storage medium is located in the memory, and the processor reads the information in the memory to complete the operations of the aforementioned method in conjunction with its hardware.

It is to be understood that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It should be noted that the memory in the systems and methods described herein is intended to include, but is not limited to, these memories and any other suitable types of memory.

It is to be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, it is further provided a computer-readable storage medium, which is configured to store a computer program.

In some embodiments, the computer readable storage medium may be applied to the core network device of the embodiments of the present disclosure, and the computer program causes a computer to implement corresponding processes implemented by the first core network device in the methods of the embodiments of the present disclosure, which will not be elaborated here for the sake of brevity.

In some embodiments, the computer readable storage medium may be applied to the access network device of the embodiments of the present disclosure, and the computer program causes a computer to implement corresponding processes implemented by the access network device in the methods of the embodiments of the present disclosure, which will not be elaborated here for the sake of brevity.

In some embodiments, the computer readable storage medium may be applied to the terminal device of the embodiments of the present disclosure, and the computer program causes a computer to implement corresponding processes implemented by the terminal device in the methods of the embodiments of the present disclosure, which will not be repeated here for the sake of brevity.

In an embodiment of the present disclosure, it is further provided a computer program product, which includes computer program instructions.

In some embodiments, the computer program product may be applied to the core network device of the embodiments of the present disclosure, and the computer program instructions cause a computer to implement corresponding processes implemented by the first core network device in the methods of the embodiments of the present disclosure, which will not be elaborated here for the sake of brevity.

In some embodiments, the computer program product may be applied to the access network device of the embodiments of the present disclosure, and the computer program instructions cause a computer to implement corresponding processes implemented by the access network device in the methods of the embodiments of the present disclosure, which will not be elaborated here for the sake of brevity.

In some embodiments, the computer program product may be applied to the terminal device of the embodiments of the present disclosure, and the computer program instructions cause a computer to implement corresponding processes implemented by the terminal device in the methods of the embodiments of the present disclosure, which will not be elaborated here for the sake of brevity.

In an embodiment of the present disclosure, it is further provided a computer program.

In some embodiments, the computer program may be applied to the core network device of the embodiments of the present disclosure, the computer program, when running on a computer, causes the computer to implement corresponding processes implemented by the first core network device in the methods of the embodiments of the present disclosure, which will not be elaborated here for the sake of brevity.

In some embodiments, the computer program may be applied to the access network device of the embodiments of the present disclosure, the computer program, when running on a computer, causes the computer to implement corresponding processes implemented by the access network device in the methods of the embodiments of the present disclosure, which will not be elaborated here for the sake of brevity.

In some embodiments, the computer program may be applied to the terminal device of the embodiments of the present disclosure, the computer program, when running on a computer, causes the computer to implement corresponding processes implemented by the terminal device in the methods of the embodiments of the present disclosure, which will not be elaborated here for the sake of brevity.

Those of ordinary skill in the art may realize that the various example units and algorithm steps described in connection with the embodiments disclosed herein can be implemented in electronic hardware or a combination of computer software and electronic hardware. Whether these functions are performed in hardware or software depends on the specific application and design constraints of the technical solution.

Professionals can use different methods for each particular application to implement the described functionality, but such implementation should not be considered beyond the scope of the present disclosure.

Those skilled in the art will clearly understand that, for convenience and conciseness of description, the specific operating processes of the above-described systems, apparatuses and units may refer to the corresponding processes in the aforementioned method embodiments and will not be repeated herein.

In several embodiments provided herein, it is to be understood that the disclosed systems, apparatuses and methods may be implemented in other manners. For example, the above-described embodiments of the apparatus is only schematic, for example, the division of the units is only a logical function division, and in practice, there may be another division manner, for example, multiple units or components may be combined or integrated into another system, or some features may be ignored or not performed. On the other hand, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over a plurality of network units. Part or all of the units can be selected according to the actual needs to achieve the purpose of the embodiments of the present disclosure.

In addition, each functional unit in each embodiment of the present disclosure may be integrated in one processing unit, each unit may exist physically alone, or two or more units may be integrated in one unit.

When the functions are implemented in the form of software functional units and sold or used as an independent product, they may be stored in a computer readable storage medium. Based on such an understanding, the technical solutions according to the disclosure in essence or the part contributing to the prior art or the part of the technical solution can be embodied in the form of a software product, and the computer software product is stored in a storage medium, which includes several instructions so that a computer device (may be a personal computer, a server, a network device or the like) implements all or part of the method according to respective embodiments of the disclosure. The aforementioned storage medium includes various media capable of storing a program code such as a USB disk, a mobile hard drive disk, a read-only memory (ROM), a random access memory (RAM), a magnetic disk or an optical disk.

The above is only the specific implementation of the present disclosure, but the scope of protection of the present disclosure is not limited thereto. Any person skilled in the art can easily think of changes or substitutions within the technical scope disclosed in the present disclosure, which should be covered within the protection scope of the present disclosure. Therefore, the scope of protection of the present disclosure shall be subject to the scope of protection of the claims.

1. A method for wireless communication, comprising:
acquiring, by an access network device, relevant information of a first unit;
wherein the first unit comprises at least one of: a first type of frame, a first type of application data unit (ADU) or a first type of encoding slice.

2. The method of claim 1, wherein the relevant information of the first unit is information corresponding to target information, and the target information comprises at least one data stream, or the target information comprises at least one service, or the target information comprises at least one application, or the target information comprises at least one quality of service (QoS) flow.

3. The method of claim 2, wherein the relevant information of the first unit corresponds to at least one piece of the target information, or the relevant information of the first unit is shared by all the target information, or the relevant information of the first unit is dedicated to one piece of the target information.

4. The method of claim 1, wherein in a case that the first unit comprises the first type of frame, the first type of frame comprises at least one of:
an I-frame, a P-frame, a B-frame, a conventional frame, a default frame, a user plane frame, a control plane frame or a special frame.

5. The method of claim 1, wherein acquiring, by the access network device, the relevant information of the first unit comprises:
acquiring, by the access network device, the relevant information of the first unit through a first core network device.

6. The method of claim 5, wherein the relevant information of the first unit is time sensitive communication assistance information (TSCAI) information.

7. The method of claim 6, wherein the TSCAI information comprises at least one of:
a transmission direction of the first unit, an arrival time of the first unit, an deviation of the arrival time of the first unit, a cycle of the first unit, a size of the first unit or Internet protocol (IP) 5-tuple information of different types of units.

8. The method of claim 5, wherein the relevant information of the first unit is second indication information, the second indication information is used to indicate the access network device to determine the first unit corresponding to target information, and the target information comprises at least one data stream, or the target information comprises at least one service, or the target information comprises at least one application, or the target information comprises at least one quality of service (QoS) flow.

9. A core network device, comprising a processor and a memory for storing a computer program, wherein the processor is configured to call and execute the computer program stored in the memory to implement following operation:
transmitting relevant information of a first unit to an access network device;
wherein the first unit comprises at least one of: a first type of frame, a first type of application data unit (ADU) or a first type of encoding slice.

10. The core network device of claim 9, wherein the relevant information of the first unit is information corresponding to target information, and the target information comprises at least one data stream, or the target information comprises at least one service, or the target information comprises at least one application, or the target information comprises at least one quality of service (QoS) flow.

11. The core network device of claim 10, wherein the relevant information of the first unit corresponds to at least one piece of the target information, or the relevant information of the first unit is shared by all the target information, or the relevant information of the first unit is dedicated to one piece of the target information.

12. The core network device of claim 9, wherein in a case that the first unit comprises the first type of frame, the first type of frame comprises at least one of:
an I-frame, a P-frame, a B-frame, a conventional frame, a default frame, a user plane frame, a control plane frame or a special frame.

13. The core network device of claim 9, wherein the relevant information of the first unit is time sensitive communication assistance information (TSCAI) information.

14. The core network device of claim 13, wherein the TSCAI information comprises at least one of:
a transmission direction of the first unit, an arrival time of the first unit, a deviation of the arrival time of the first unit, a cycle of the first unit, a size of the first unit or Internet protocol (IP) 5-tuple information of different types of units.

15. The core network device of claim 9, wherein the relevant information of the first unit is second indication information, the second indication information is used to indicate the access network device to determine the first unit corresponding to target information, and the target information comprises at least one data stream, or the target information comprises at least one service, or the target information comprises at least one application, or the target information comprises at least one quality of service (QoS) flow.

16. The core network device of claim 15, wherein the processor is further configured to call and execute the computer program stored in the memory to implement following operation:
transmitting first information to a third core network device, the first information being used by the third core network device to identify different types of the first unit.

17. The core network device of claim 9, wherein the processor is further configured to call and execute the computer program stored in the memory to implement following operation:
receiving the relevant information of the first unit sent by a second core network device.

18. The core network device of claim 17, wherein the core network device is a session management function (SMF) entity and the second core network device is a policy control function (PCF) entity.

19. An access network device, comprising a processor and a memory for storing a computer program, wherein the processor is configured to call and execute the computer program stored in the memory to implement following operation:
acquiring relevant information of a first unit;
wherein the first unit comprises at least one of: a first type of frame, a first type of application data unit (ADU) or a first type of encoding slice.

20. The access network device of claim 19, wherein the relevant information of the first unit is information corresponding to target information, and the target information comprises at least one data stream, or the target information comprises at least one service, or the target information comprises at least one application, or the target information comprises at least one quality of service (QoS) flow.
